(19) United States
(12) Patent Application Publication
(10) Pub. No.: US 2026/0050807 A1
(43) Pub. Date: Feb. 19, 2026

(54) METHOD AND SYSTEM OF TRAINING AN ENCODER CLASSIFIER MODEL IN PREDICTING HALLUCINATION OF A MACHINE LEARNING (ML) MODEL BEFORE A GENERATION OF A QUERY

(71) Applicant: JPMorgan Chase Bank, N.A., New York, NY (US)

(72) Inventors: William WATSON, Long Beach, NY (US); Naan CHO, New York, NY (US); Nishan SRISHANKAR, Secaucus, NJ (US)

(73) Assignee: JPMorgan Chase Bank, N.A., New York, NY (US)

(21) Appl. No.: 18/806,279

(22) Filed: Aug. 15, 2024

(51) Int. Cl. G06N 7/01

(52) U.S. Cl. CPC G06N 7/01

(57) ABSTRACT

A method and system for training an encoder classifier model in predicting hallucination of a machine learning (ML) model before a generation of a query. The method includes implementing a plurality of independent large language models (LLMs) that each perturb a plurality of training queries for a predetermined number (n) of times, wherein the plurality of LLMs comprises n+1; utilizing the plurality of LLMs in performing functions including: generating a perturbed output for each of the plurality of training queries by perturbing the plurality of training queries; sampling an initial training query and each of the perturbed outputs; and deriving empirical probability estimations of hallucinations via a computational statistical simulation on the sampled outputs; and training the encoder classifier model based on the derived empirical probability estimations that predicts the hallucination in the ML model associated with the query before the generation of the query.

### BACKGROUND

### 1. Field of the Disclosure

This technology generally relates to methods and systems of training an encoder classifier model in predicting hallucination of a machine learning (ML) model before a generation of a query.

### 2. Background Information

Large language models (LLMs) are often used in processing large volumes of data, e.g., textual data, to generate natural language responses that mimic human responses. However, despite their prevalence, the false perception of patterns or objects resulting, i.e., hallucinations, in LLMs continues to be one of the most critical challenges in the institutional adoption journey of LLMs.

Present research in the status quo have primarily focused on the post-generation analysis and refinement of outputs in LLMs. There has not been research into the effectiveness of queries in eliciting accurate responses from LLMs, notably, in estimating a query's propensity to result in a hallucination by the LLMs before the query is generated and utilized.

Accordingly, there is a need for techniques to train an encoder classifier model in predicting hallucination of ML models that utilizes a query before the query is generated.

### SUMMARY

The present disclosure, through one or more of its various aspects, embodiments, and/or specific features or sub-components, provides, inter alia, various systems, servers, devices, methods, media, programs, and platforms for training an encoder classifier model in predicting hallucination of a machine learning (ML) model.

According to an aspect of the present disclosure, a method of training an encoder classifier model in predicting hallucination of a machine learning (ML) model before a generation of a query may be provided. The method may be implemented by at least one processor. The method may include implementing a plurality of independent large language models (LLMs) that each perturb a plurality of training queries for a predetermined number (n) of times, wherein the plurality of LLMs comprises n+1.

The method may further include utilizing the plurality of LLMs in performing functions that may comprise: generating a perturbed output for each of the plurality of training queries by perturbing the plurality of training queries; sampling an initial training query and each of the perturbed outputs; and deriving empirical probability estimations of hallucinations via a computational statistical simulation on the sampled outputs.

The method may further include training the encoder classifier model based on the derived empirical probability estimations that predicts the hallucination in the ML model associated with the query before the generation of the query.

Each of the perturbed outputs may comprise a semantically equivalent and lexically distinct variation corresponding to each of the plurality of training queries.

The training the encoder classifier model may comprise at least one from among: training the encoder classifier model in generating a binary classification that predicts whether the query results in the hallucination in the ML model; and training the encoder classifier model with a non-reinforcement learning technique resulting in a consensus-aware proxy reward model with a feedback mechanism.

The consensus-aware proxy reward model may generate: a probabilistic feedback regarding the quality of the query; and a single-shot iterative automated rewrite of the query based on the probabilistic feedback.

The query, the plurality of training queries, and the initial training query may belong to an initial data class type that may comprise at least one from among: extractive data class type, multiple-choice data class type, and abstractive class type.

The method may further comprise: performing a ranking of the perturbed plurality of training queries based on a best-of-n strategies for utilization by the LLMs in the sampling; and routing the query across different modes of the trained encoder classifier model that correlate to a second data class type that differs from the initial data class type.

The computational statistical simulation may comprise a multi-agent Monte Carlo simulation; and each of the independent LLMs comprises a generative pre-trained transformer (GPT) LLM.

According to another embodiment, a computing apparatus for training an encoder classifier model in predicting hallucination of a machine learning (ML) model before a query generation may be provided. The computing apparatus comprising: a processor; a memory; a display; and a communication interface coupled to each of the processor, the memory, and the display.

The processor may be configured to implement a plurality of independent large language models (LLMs) that each perturb a plurality of training queries for a predetermined number (n) of times, wherein the plurality of LLMs comprises n+1.

The processor may be configured to utilize the plurality of LLMs in performing functions comprising: generate a perturbed output for each of the plurality of training queries by perturbing the plurality of training queries; sample an initial training query and each of the perturbed outputs; and derive empirical probability estimations of hallucinations via a computational statistical simulation on the sampled outputs.

The processor may be configured to train the encoder classifier model based on the derived empirical probability estimations that predicts the hallucination in the ML model associated with the query before the generation of the query.

Each of the perturbed outputs may comprise a semantically equivalent and lexically distinct variation corresponding to each of the plurality of training queries.

The processor may be further configured to train the encoder classifier model by at least one from among: training the encoder classifier model in generating a binary classification that predicts whether the query results in the hallucination in the ML model; and training the encoder classifier model with a non-reinforcement learning technique resulting in a consensus-aware proxy reward model with a feedback mechanism.

The processor may be further configured to implement the consensus-aware proxy reward model to generate: a probabilistic feedback regarding the quality of the query; and a single-shot iterative automated rewrite of the query based on the probabilistic feedback.

The query, the plurality of training queries, and the initial training query may belong to an initial data class type that may comprise at least one from among: extractive data class type, multiple-choice data class type, and abstractive class type.

The processor may be further configured to: perform a ranking of the perturbed plurality of training queries based on a best-of-n strategies for utilization by the LLMs in the sampling; and route the query across different modes of the trained encoder classifier model that correlate to a second data class type that differs from the initial data class type.

The computational statistical simulation may comprise a multi-agent Monte Carlo simulation; and each of the independent LLMs may comprise a generative pre-trained transformer (GPT) LLM.

According to yet another embodiment, a non-transitory computer readable storage medium storing instructions for training an encoder classifier model in predicting hallucination of a machine learning (ML) model before a query generation may be provided. The non-transitory computer readable storage medium comprising executable code which, when executed by a processor, causes the processor to: implement a plurality of independent large language models (LLMs) that each perturb a plurality of training queries for a predetermined number (n) of times, wherein the plurality of LLMs comprises n+1.

The non-transitory computer readable storage medium storing instructions may further cause the processor to utilize the plurality of LLMs in performing functions comprising: generate a perturbed output for each of the plurality of training queries by perturbing the plurality of training queries; sample an initial training query and each of the perturbed outputs; and derive empirical probability estimations of hallucinations via a computational statistical simulation on the sampled outputs.

The non-transitory computer readable storage medium storing instructions may further cause the processor to train the encoder classifier model based on the derived empirical probability estimations that predicts the hallucination in the ML model associated with the query before the generation of the query.

The each of the perturbed outputs may comprise a semantically equivalent and lexically distinct variation corresponding to each of the plurality of training queries; wherein the computational statistical simulation comprises a multi-agent Monte Carlo simulation; and wherein each of the independent LLMs comprises a generative pre-trained transformer (GPT) LLM.

The executable code may further cause the processor to train the encoder classifier model by at least one from among: training the encoder classifier model in generating a binary classification that predicts whether the query results in the hallucination in the ML model; and training the encoder classifier model with a non-reinforcement learning technique resulting in a consensus-aware proxy reward model with a feedback mechanism.

The executable code may further cause the processor to implement the consensus-aware proxy reward model to generate: a probabilistic feedback regarding the quality of the query; and a single-shot iterative automated rewrite of the query based on the probabilistic feedback.

The query, the plurality of training queries, and the initial training query may belong to an initial data class type that may comprise at least one from among: extractive data class type, multiple-choice data class type, and abstractive class type.

The non-transitory computer readable storage medium storing instructions may further cause the processor to perform processes that may comprise: performing a ranking of the perturbed plurality of training queries based on a best-of-n strategies for utilization by the LLMs in the sampling; and routing the query across different modes of the trained encoder classifier model that correlate to a second data class type that differs from the initial data class type.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a system diagram of a computer system.

FIG. 2 illustrates a network diagram of a network environment.

FIG. 3 illustrates a diagram of a system environment according to an embodiment for training an encoder classifier model in predicting hallucination of a machine learning (ML) model before a generation of a query.

FIG. 4 illustrates a flowchart of a process for training an encoder classifier model in predicting hallucination of a machine learning (ML) model before a generation of a query diagram according to an embodiment.

FIG. 5 illustrates an example overview process flow of training an encoder classifier model in predicting hallucination of a machine learning (ML) model before a generation of a query according to an embodiment.

FIG. 6 illustrates an example training process graph of training an encoder classifier model in predicting hallucination of a machine learning (ML) model before a generation of a query according to an embodiment.

FIG. 7 illustrates example calibration graphs for training an encoder classifier model in predicting hallucination of a machine learning (ML) model before a generation of a query according to an embodiment.

FIG. 8 illustrates example predicted hallucination matrices of training an encoder classifier model in predicting hallucination of a machine learning (ML) model before a generation of a query according to an embodiment.

FIG. 9 illustrates an example graph of distributions of observed number of hallucinations associated with different data scenarios of training an encoder classifier model in predicting hallucination of a machine learning (ML) model before a generation of a query according to an embodiment.

FIG. 10 illustrates an example binary distribution of data labels associated with training an encoder classifier model in predicting hallucination of a machine learning (ML) model before a generation of a query according to an embodiment.

FIG. 11 illustrates an example probability graph of queries being rewritten and re-classified as non-hallucinatory as part of training an encoder classifier model in predicting hallucination of a machine learning (ML) model before a generation of a query according to an embodiment.

FIG. 12 illustrates an example operation of a large language model (LLM) as part of training an encoder classifier model in predicting hallucination of a machine learning (ML) model before a generation of a query according to an embodiment.

### DETAILED DESCRIPTION

Large language models (LLMs) are often used in processing large volumes of data, e.g., textual data, to generate natural language responses that mimic human responses. However, despite their prevalence, the false perception of patterns or objects resulting, i.e., hallucinations, in LLMs continues to be one of the most critical challenges in the institutional adoption journey of LLMs. That is, despite the promising potential for a myriad of use cases, LLMs offer limited insights into their chain of thought and have the propensity to hallucinate. Common factors that drive hallucinations encompass high model complexity, flawed data sources or inherent sampling randomness. Specifically, the intrinsic trade-off between greedy deterministic decoding and the creativity spawned through nucleus sampling induces a heightened propensity to hallucinate.

Additionally, since LLMs frequently advance output quality through different sampling methods, the challenge of understanding hallucinations may be compounded by limitations such as the frequent inaccessibility into the LLMs' training datasets. As such, resolving hallucination-related issues via the concerted effort of evaluating different LLM is an important issue that needs to be addressed and resolved.

Present research in the status quo have primarily focused on the post-generation analysis and refinement of outputs in LLMs. There has not been research into the effectiveness of queries in eliciting accurate responses from LLMs, notably, in estimating a query's propensity to result in a hallucination by the LLMs before the query is generated and utilized. That is, the majority of current studies have focused on: the post-generation phase of output analysis, such as self-refinement via feedback loops on the model's output or analysis of logit output values to detect hallucination; or the pre-generation phase, such as the ingestion of recent knowledge to improve performance.

The present application addresses these limitations in the status quo by disclosing an encoder classifier model, dubbed HalluciBot, in predicting hallucination of a machine learning (ML) model before a generation of a query. The encoder classifier model may predict the probability of hallucination before any generation for a given query. By doing so, the present application refocuses the study of hallucination to an empirical evaluation of the input query, namely how much the query's quality influences the propensity of the ML model, which may be an LLM, to hallucinate. Therefore, given the ML model, the encoder classifier model may estimate a binary classification of the query's propensity to hallucinate (“Yes” or “No”), as well as, a non-reinforcement learning method to guide query rewriting, enabling the construction of the encoder classifier model to be agnostic to closed-source or open-source LLMs.

The concept of hallucination, in general terms, hallucination refers to a false perception of patterns or objects resulting from one's senses. With regards to LLMs, various of studies in the status quo bifurcate into (1) factuality hallucinations that refer to outputs which directly contradict or fabricate the ground truth while (2) faithfulness hallucinations define outputs that misunderstand the context or intent of the query. In contrast to the status quo, the present application introduces truthful hallucination as the motivation for why the original query are being perturbed. Truthful hallucination may be defined as an LLM's inability to answer semantically similar but lexically different perturbations of a query. The motivation for truthful hallucination stems from the analysis that neural networks display an intrinsic propensity to memorize training data, i.e., memorizing the query and output in the present application. Given the risk of over-training LLMs with their opaque training data and propensity to memorize, generating multiple outputs from the same query or analyzing a single output from a single query do not help measure truthful hallucination.

Therefore, the present application discloses an encoder classifier model/encoder-based classifier model, dubbed HalluciBot (these various terms may be used interchangeably to mean the same thing), that may focus on distilling LLM behavior into a speedy, encoder-based system that may be predict hallucination before generation. This is in contrast to the status quo, which uses multiple generations during a user's session to provide self-consistency. Additionally, the present application also differs from entropy-based, logarithmic-probability-based, or model-based estimation techniques that rely on the LLM's uncertainty to predict hallucinations because those methods focus on the LLM's bias while the present focuses on empirical estimates. Moreover, the present application includes a multi-agent Monte Carlo simulation which is markedly different than the experiments in the status quo that have focused on leveraging a single LLM agent to generate outputs from a single query.

In an example, the training procedure for HalluciBot includes perturbing each query n=5 times, employing n+1=6 independent LLM agents, sampling an output from each query, conducting a multi-agent Monte Carlo simulation on e.g., 2,219,022 sampled data outputs, and training an encoder classifier. It is noted that these values are example values and are not intended to limit or restrict the present application to those values. Notably, HalluciBot may estimate a query's propensity to hallucinate before generation without invoking any LLMs during inference. Additionally, HalluciBot may serve as a proxy reward model for query rewriting, offering a general framework to estimate query quality based on accuracy and consensus. In essence, HalluciBot may investigate how poorly constructed queries can lead to erroneous outputs. Furthermore, by employing query rewriting guided by HalluciBot's empirical estimates, an output accuracy of e.g., 95.7% may be achieved for Multiple Choice questions.

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

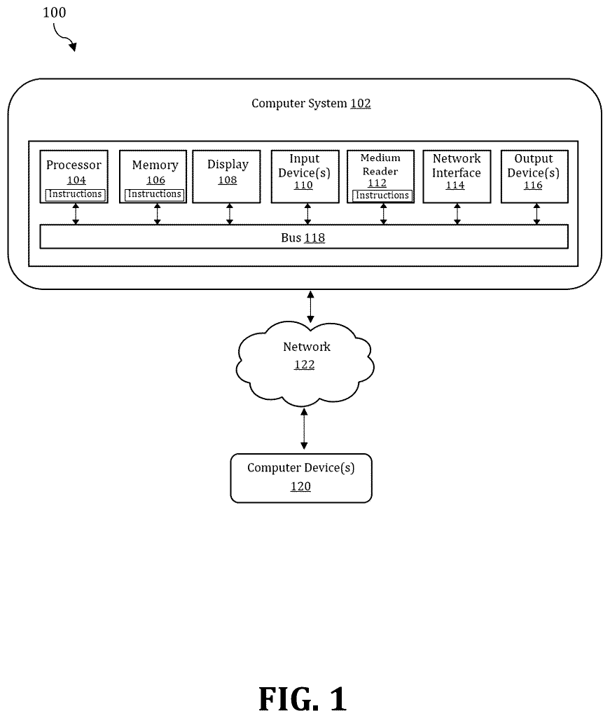

FIG. 1 illustrates a system 100 diagram of a computer system 102 for use in accordance with the embodiments described herein. The system 100 may be generally shown and may include a computer system 102, which may be generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 may be illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, digital optical disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but not limited to, a local area network, a wide area network, the Internet, a telephony network, a short-range network, or any other network commonly known and understood in the art. The short-range network may include, for example, short-range wireless technology standard used for exchanging data between fixed devices and mobile devices over short distances, low-power wireless ad-hoc mesh networks for linking together, infrared, near field communication, ultra-wideband, or any combination thereof. Those skilled in the art appreciate that additional networks 122 which are known and understood may additionally or alternatively be used and that the networks 122 are not limiting or exhaustive. Also, while the network 122 may be illustrated in FIG. 1 as a wireless network, those skilled in the art appreciate that the network 122 may also be a wired network.

The additional computer device 120 may be illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely examples of devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be examples and are not intended to be exhaustive and/or inclusive. Furthermore, the examples of the components listed above are also similarly not meant to be exhaustive and/or inclusive.

In accordance with various embodiments of the present disclosure, the methods described herein may be implemented using a hardware computer system that executes software programs. Further, in a non-limiting embodiment, implementations may include distributed processing, component/object distributed processing, and parallel processing. Virtual computer system processing may be constructed to implement one or more of the methods or functionalities as described herein, and a processor described herein may be used to support a virtual processing environment.

As described herein, various embodiments provide optimized methods and systems of training an encoder classifier model in predicting hallucination of a machine learning (ML) model before a generation of a query.

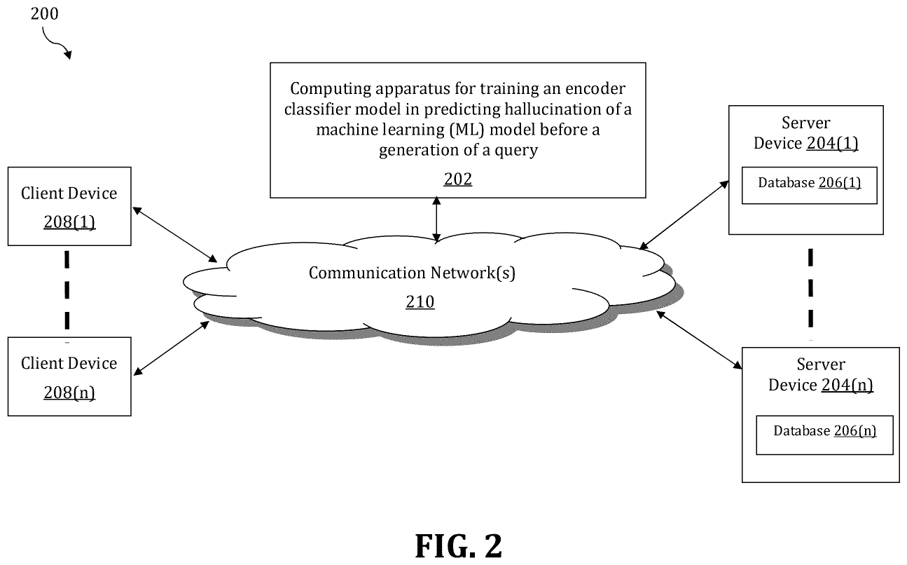

Referring to FIG. 2, a network diagram of a network environment 200 for training an encoder classifier model in predicting hallucination of a machine learning (ML) model before a generation of a query may be illustrated. In an embodiment, the method may be executable on any networked computer platform, such as, for example, a personal computer (PC).

The method of training an encoder classifier model in predicting hallucination of a machine learning (ML) model before a generation of a query) may be implemented by a computing apparatus 202 that implements the training of an encoder classifier model in predicting hallucination of a ML model before a generation of a query. The computing apparatus 202 may be the same or similar to the computer system 102 as described with respect to FIG. 1. The computing apparatus 202 may store one or more applications that may include executable instructions that, when executed by the computing apparatus 202, cause the computing apparatus 202 to perform actions, such as to transmit, receive, or otherwise process network messages, for example, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s) may be located in virtual server(s) running in a cloud-based computing environment rather than being tied to one or more specific physical network computing devices. Also, the application(s) may be running in one or more virtual machines (VMs) executing on the computing apparatus 202. Additionally, in one or more embodiments of this technology, virtual machine(s) running on the computing apparatus 202 may be managed or supervised by a hypervisor.

In the network environment 200 of FIG. 2, the computing apparatus 202 may be coupled to a plurality of server devices 204(1)-204(n) that hosts a plurality of databases 206(1)-206(n), and also to a plurality of client devices 208(1)-208(n) via communication network(s) 210. A communication interface of the computing apparatus 202, such as the network interface 114 of the computer system 102 of FIG. 1, operatively couples and communicates between the computing apparatus 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used. The server devices 204(1)-204(n) and/or the client devices 208(1)-208(n) may provide different computing environments.

The communication network(s) 210 may be the same or similar to the network 122 as described with respect to FIG. 1, although the computing apparatus 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and computing apparatus that efficiently implement a method of training an encoder classifier model in predicting hallucination of a ML model before a generation of a query.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, for example, tele-traffic in any suitable form (e.g., voice, modem, and the like), Public Switched Telephone Network (PSTNs), Ethernet-based Packet Data Networks (PDNs), combinations thereof, and the like.

The computing apparatus 202 may be a standalone device or integrated with one or more other devices or apparatuses, such as one or more of the server devices 204(1)-204(n), for example. In one particular example, the computing apparatus 202 may include or be hosted by one of the server devices 204(1)-204(n), and other arrangements are also possible. Moreover, one or more of the devices of the computing apparatus 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the computing apparatus 202 via the communication network(s) 210 according to the HTTP-based and/or script object notation protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store information.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that may interact with the computing apparatus 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an embodiment, at least one client device 208 may be a wireless mobile communication device, i.e., a smart phone.

The client devices 208(1)-208(n) may run interface applications, such as standard web browsers or standalone client applications, which may provide an interface to communicate with the computing apparatus 202 via the communication network(s) 210 in order to communicate user requests and information. The client devices 208(1)-208(n) may further include, among other features, a display device, such as a display screen or touchscreen, and/or an input device, such as a keyboard, for example.

Although the network environment 200 with the computing apparatus 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems described herein are for example purposes, as many variations of the specific hardware and software used to implement the examples are possible, as will be appreciated by those skilled in the relevant art(s).

One or more of the devices depicted in the network environment 200, such as the computing apparatus 202, the server devices 204(1)-204(n), or the client devices 208(1)-208(n), for example, may be configured to operate as a virtual instance on the same physical machine. In other words, one or more of the computing apparatus 202, the server devices 204(1)-204(n), or the client devices 208(1)-208(n) may operate on the same physical device rather than as separate devices communicating through communication network(s) 210. Additionally, there may be more or fewer computing apparatus 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only tele-traffic in any suitable form (e.g., voice and modem), wireless traffic networks, cellular traffic networks, Packet Data Networks (PDNs), the Internet, intranets, and combinations thereof.

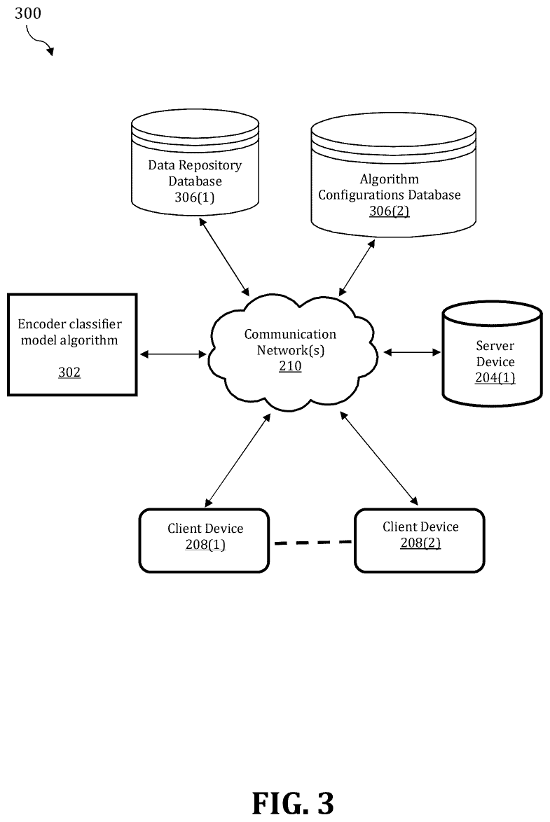

The computing apparatus 202 may be described and illustrated in FIG. 3 as including an encoder classifier model algorithm 302, although it may include other rules, algorithms, policies, modules, databases, or applications, for example. As will be described below, the encoder classifier model algorithm 302 may be configured to implement a method of training an encoder classifier model in predicting hallucination of a ML model before a generation of a query.

FIG. 3 illustrates a diagram of a system environment 300 for implementing a method of training an encoder classifier model in predicting hallucination of a machine learning (ML) model before a generation of a query of FIG. 2, which may be illustrated as being executed in FIG. 3. Specifically, a first client device 208(1) and a second client device 208(2) are illustrated as being in communication with computing apparatus 202. In this regard, the first client device 208(1) and the second client device 208(2) may be “clients” of the computing apparatus 202 and are described herein as such. Nevertheless, it is to be known and understood that the first client device 208(1) and/or the second client device 208(2) need not necessarily be “clients” of the computing apparatus 202, or any entity described in association therewith herein. Any additional or alternative relationship may exist between either or both of the first client device 208(1) and the second client device 208(2) and the computing apparatus 202, or no relationship may exist.

Further, computing apparatus 202 may be illustrated as being able to access a data repository database 306(1) and an algorithm configurations database 306(2). The encoder classifier model algorithm 302 may be configured to access these databases for implementing the training of an encoder classifier model in predicting hallucination of a ML model before a generation of a query.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an embodiment, either or both of the first client device 208(1) and the second client device 208(2) may communicate with the computing apparatus 202 via broadband or cellular communication. Of course, these embodiments are merely examples and are not limiting or exhaustive.

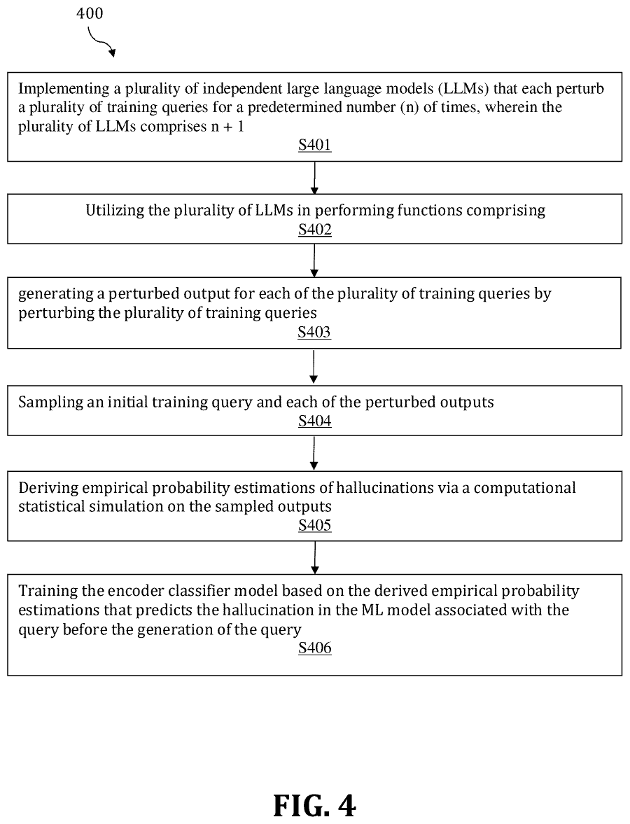

Upon being started, the encoder classifier model algorithm 302 executes a process implementing a method of training an encoder classifier model in predicting hallucination of a ML model before a generation of a query. A process for training an encoder classifier model in predicting hallucination of a ML model before a generation of a query may be generally indicated at flowchart 400 in FIG. 4.

FIG. 4 illustrates a flowchart of a process diagram 400 of a process for training an encoder classifier model in predicting hallucination of a machine learning (ML) model before a generation of a query according to an embodiment. At step S401 of the flowchart process 400, the computing apparatus 202 may implement a plurality of independent large language models (LLMs) that each perturb a plurality of training queries for a predetermined number (n) of times, wherein the plurality of LLMs comprises n+1.

At step S402, the computing apparatus 202 may utilizing the plurality of LLMs in performing functions comprising: generating a perturbed output for each of the plurality of training queries by perturbing the plurality of training queries (step S403); sampling an initial training query and each of the perturbed outputs (step S404); and deriving empirical probability estimations of hallucinations via a computational statistical simulation on the sampled outputs (step S405).

Continuing with step S403, each of the perturbed outputs comprises a semantically equivalent and lexically distinct variation corresponding to each of the plurality of training queries. Furthermore, the query, the plurality of training queries, and the initial training query may belong to an initial data class type comprising at least one from among: extractive data class type, multiple-choice data class type, and abstractive class type. Extractive data class type may involve extracting answers directly from a given context. For instance, extractive data class type may involve extracting answers directly from a given context, which may be accomplished using e.g., span-detection encoders that predict the start and end tokens of the relevant portion in the context.

Continuing with step S403, multiple-choice data class type may involve a task in few-shot learning where a model may be given a question and a set of answer choices. In multiple-choice data class type, a task may involve few-shot learning with a question and a set of answer choices. Usually, one of the choices is correct, while the rest are distractors. In an encoder-based approach, a model may replicate the question for each choice, generate a scalar response, and apply a softmax across the choices to determine the best answer. In a generative setting, the model may generate an answer choice instead of selecting from the given options, using few-shot prompting techniques.

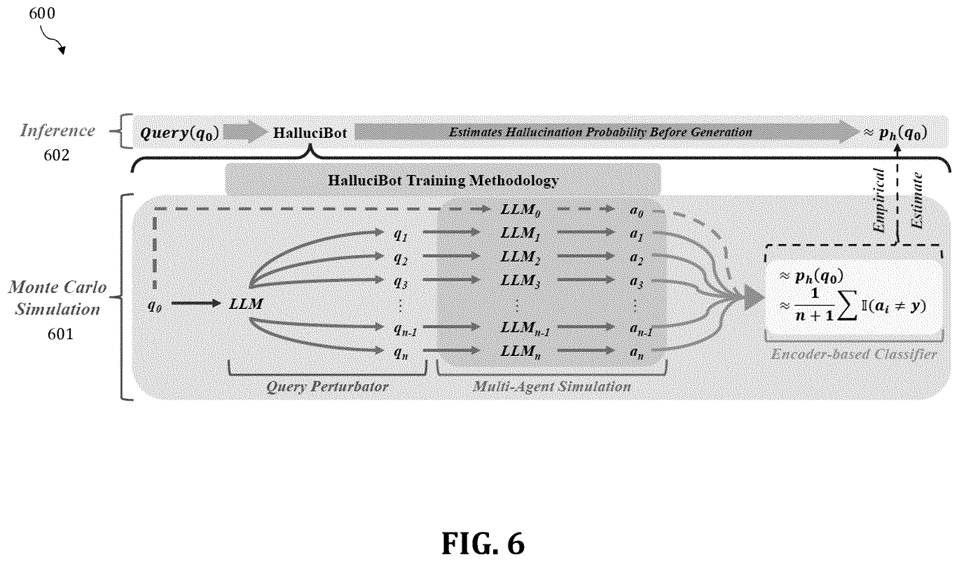

Continuing with step S403, abstractive data class type (also known as closed-book generative data class type) may involve the generation of answers without access to context or candidates. For instance, when no context may be provided, abstractive techniques are used to generate answers based solely on the question. Encoder models may be employed in this approach to convert commonly occurring answer tokens into class labels. A multi-class model may then be trained using softmax function (e.g., softmax regression) to predict the answer from the question. Further details regarding the softmax function are described below in FIG. 6.

It may be noted that while a softmax function may be used, an alternative function (e.g., ordinal regression) may also be used. Ordinal Regression, in contrast to softmax regression, learns a sequence of cut points to divide the prediction space into classes, allowing a model (e.g., but not limited to, the encoder classifier model) to bias errors to the nearest class label. This may be useful when the class labels have order, such as estimating the number of stars for a review or the expected rate of hallucination. In an example, let f(x) be an encoder classifier model that may output a single scalar score, such that f(x)→R. Additionally, let σ(x) be the Sigmoid function as shown below.

$$σ ( x ) = \frac{1}{1 + exp ( - x )}$$

Therefore, the probability of a binary ordinal classifier centered at cutoff point 0 that differentiates the in log-probability space of the positive and negative outcomes may be shown below.

$$\begin{matrix}p ( y = 1 \vert x ) = σ ( f ( x ) ) \\ p ( y = 0 \vert x ) = 1 - p ( y = 1 \vert x ) \\ = 1 - σ ( f ( x ) )\end{matrix}$$

Continuing with ordinal regression, by expanding to several classes K, the probability space may be divided into K−1 cut points c₁, . . . , c_{K-1} with the property that c₁<c₂ . . . c_{K-1}, such that the probability for each class may be defined as shown below.

$$\begin{matrix}p ( y = 0 \vert x ) = σ ( {c}_{1} - f ( x ) ) \\ ⋮ \\ p ( y = k \vert x ) = σ ( {c}_{k + 1} - f ( x ) ) - σ ( {c}_{k} - f ( x ) ) \\ ⋮ \\ p ( y = K - 1 \vert x ) = 1 - σ ( {c}_{K - 1} - f ( x ) )\end{matrix}$$

To enforce the property c₁<c₂ . . . c_{K-1} while allowing the thresholds to be differentiable, a cumulative sum may be used on a set of unbounded, learnable parameters θ₁, . . . , θ_{K-1}, transformed by a softplus (β=1) to avoid adding negative values; thus, ensuring that the thresholds may be always increasing. Therefore, each cut point cₖ may be of the form as shown below.

$$\begin{matrix}Softplus ( {θ}_{k} ) = \frac{1}{β} \cdot log ( 1 + exp ( β \cdot {θ}_{k} ) ) > 0 \\ {c}_{1} = {θ}_{1} \\ {c}_{k} = {θ}_{1} + {\sum }_{i = 2}^{k} Softplus ( {θ}_{i} )\end{matrix}$$

Continuing with step S405 the computational statistical simulation may comprise a multi-agent Monte Carlo simulation and each of the independent LLMs may comprise a generative pre-trained transformer (GPT) LLM.

At step S406, the computing apparatus 202 may implement the training the encoder classifier model based on the derived empirical probability estimations that predicts the hallucination in the ML model associated with the query before the generation of the query. The training the encoder classifier model may comprise at least one from among: training the encoder classifier model in generating a binary classification that predicts whether the query results in the hallucination in the ML model; and training the encoder classifier model with a non-reinforcement learning technique resulting in a consensus-aware proxy reward model with a feedback mechanism. The consensus-aware proxy reward model may perform: a probabilistic feedback regarding the quality of the query; and a single-shot iterative automated rewrite of the query based on the probabilistic feedback.

Additionally, the process for training an encoder classifier model in predicting hallucination of a ML model before a generation of a query may further include the computing apparatus 202 performing a ranking of the perturbed plurality of training queries based on a best-of-n strategies for utilization by the LLMs in the sampling, and routing the query across different modes of the trained encoder classifier model that correlate to a second data class type that differs from the initial data class type.

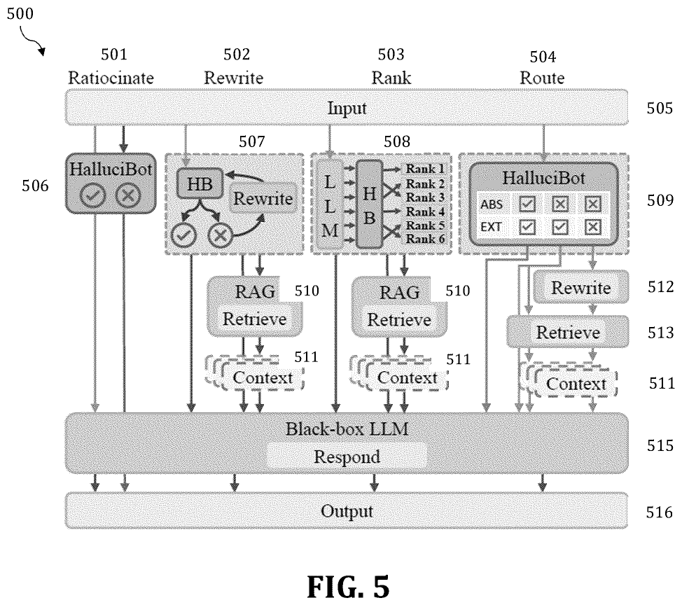

FIG. 5 illustrates an example overview process flow 500 of training an encoder classifier model in predicting hallucination of a machine learning (ML) model before a generation of a query according to an embodiment.

The encoder classifier model, dubbed HalluciBot, may involve four aspects (ratiocinate, rewrite, rank, and route). The encoder classifier model may be used to assess the query's quality before generation, enabling an instant insight into the hallucination risk of the query 506 (“Ratiocinate” 501), automation of the query rewriting stage through informed feedback (“Rewrite” 502) or best-of-n sampling across multiple candidates (“Rank” 503), and routing the query across different operating modes (“Route” 504), since HalluciBot is scenario-aware (extractive/abstractive), potentially bypassing computationally expensive stages, such as retrieval augmented generation (RAG) 510 or rewrite 512.

In an example, the instant insights into the hallucination risk of the query 506 may be obtained via HalluciBot. For instance, at the “Ratiocinate” 501 step, input data 505 (for example but not limited to a training query) may be inputted into the HalluciBot, which may perform an evaluation of the input data 505 that results in the instant insights into the hallucination risk of the query 506. These insights may be transmitted to a black box LLM 515 that may respond to the insights and generate an output 516.

The “Rewrite” 502 process may leverage the probabilities to improve the query's quality via rewriting with iterative feedback 507. If the quality of the query in its initial/original form does not result in a hallucination or results in a minimal risk of a hallucination below a predetermined threshold that may be deemed acceptable for a particular operation, then the query may be transmitted to a black box LLM 515 that may respond to the query and generate an output 516. That is, no rewrite with an iterative feedback 507 process, no Retrieval-Augmented Generation (RAG) 510, and no Context 511 may be needed prior to being transmitted to the black box LLM 515.

Continuing with the “Rewrite” 502 process, if the query in its initial/original form results in a hallucination or a risk of a hallucination above the predetermined threshold, then the query may need to be rewritten with an iterative feedback 507 process until the rewritten query does not result in the hallucination or results in a minimal risk of a hallucination below the predetermined threshold. The rewritten query may then be transmitted to a black box LLM 515 that may respond to the rewritten query and generate an output 516.

The “Rank” 503 process may involve inputting the input data 505 into at least one LLM, as part of multi-agents (e.g., multiple LLMs), to generate a respective perturbation of the input data for input into the encoder classifier model dubbed HalluciBot (HB), wherein the perturbations may be ranked using probabilities as a proxy reward model via best-of-n sampling 508. Alternatively, the perturbations with a ranking above a predetermined ranking threshold, e.g., via a best-of-n sampling 508 process, may utilize the RAG 510 process and the Context 511 process prior to being transmitted to the black box LLM 515 that may respond to the ranked perturbations and generate an output 516. The RAG process 510 may involve a generation of an answer based on a selected passage containing the necessary information.

Continuing with the “Rank” 503 process, the perturbations with a ranking above a predetermined ranking threshold, e.g., via a best-of-n sampling 508 process, may be transmitted to a black box LLM 515 that may respond to the ranked perturbations and generate an output 516 without needing a Retrieval-Augmented Generation (RAG) 510 process and without needing a Context 511 process. Further details regarding the perturbations are described in FIG. 6.

The “Route” 504 process may involve routing for the next steps depending on scenarios such as extractive data class types or abstractive data class types. That is, by cross-tabulating the predicted hallucination rates across scenarios, HalluciBot may act as a router through which certain queries may be transmitted to a black-box LLM 515 for generation of an output 516, while other queries may require a more complex pipeline including a rewrite 512, retrieval 513, and a context 514 for a contextual retrieval. The context pipeline may also include a web search or agents (not shown in FIG. 6). That is, a complex pipeline may be needed for the query prior to being transmitted to the black-box LLM 515 for generation of an output 516.

FIG. 6 illustrates an example training process graph 600 of training an encoder classifier model in predicting hallucination of a machine learning (ML) model before a generation of a query according to an embodiment.

The encoder classifier model, dubbed HalluciBot, may be trained as a binary classifier to predict whether a query will lead to erroneous outputs. To generate ground truth labels as part of training the encoder classifier model, a Monte Carlo simulation 601 using multi-agents comprised of LLMs may be used that perturbs the query and checks for inaccuracies. That is, in an example, HalluciBot may leverage at least one LLM to perform the multi-agent Monte Carlo simulation 601, wherein the least one LLM may be a generative pre-trained transformer (GPT) model. If any perturbed version causes an error, the original query may be labeled as hallucinatory.

HalluciBot may be trained via: (1) perturbing a plurality of queries (e.g., 369,837 queries) n times to retain the original semantic meaning and yet lexically divergent meaning; (2) employing n+1 independent LLM agents to sample an output from each perturbation including the original query, at a temperature (T) of e.g., 1.0 for diversity; (3) conducting a Monte Carlo simulation 601 on a plurality of sampled outputs (e.g., 2,219,022 sampled outputs); and (4) deriving an empirical estimate into the expected rate of hallucination pₕ(q₀) for the original query. In an example, it may be proven that introducing perturbations before sampling n+1 outputs for query q₀ may garner a 13.2 point spread in the lower and upper bound accuracy, with e.g., a 12.5-point decrease in Fleiss's κ for agreement, even as the modal accuracy remains largely unchanged (e.g., at a 1.3-point difference). In other words, perturbations introduce more variability in the outputs, while preserving the central tendency.

Regarding the concept of temperature, temperature (T) may be used to control the smoothing of a data sample distribution. For instance, decoder-based language models approximate the distribution of the next probable token across a given vocabulary V. This may often be implemented by applying the softmax function across a language model's final output vector uᵢ, per token xᵢ. That is, greedy decoding may take the most likely predicted token of the output distribution per sequence step, but may often yield poor results and a lack of diversity. The softmax function is shown below.

$$p ( {y}_{i} \vert {x}_{1 : i - 1} ) = \frac{{e}^{{u}_{i}}}{{\sum }_{j} {e}^{{u}_{j}}}$$

To combat this issue with greedy decoding, an alternative approach may leverage multinomial sampling across the data sample distribution to sample less likely tokens. As such, temperature (T) may be used to control the smoothing of the distribution. As T→∞, the output data sample distribution may be smoother and more uniform. Therefore, unlikely tokens become more likely to be sampled. As T→0, the data sample distribution approaches a Kronecker Delta (δᵢⱼ) function, centered on the token with the most probability mass and that mimics the greedy decoding strategies. Thus, temperature may often be implemented as an adjusted softmax function, with a revised softmax function with temperature (T) as shown below.

$$p ( {y}_{i} \vert {x}_{1 : i - 1} ) = \frac{{e}^{{u}_{i} / T}}{{\sum }_{j} {e}^{{u}_{j} / T}}$$

However, sampling across the full vocabulary may lead an LLM to produce extremely unlikely generations. To restrict the space of possible outcomes, two approaches exist: (1) Top-K Sampling and (2) nucleus sampling. Top-K sampling may be implemented to include tokens that are in the Top-K most probable tokens. A limitation in Top-K may be the static window of possible tokens considered, wherein unlikely tokens may still be considered even if most of the probability mass may be distributed amongst fewer tokens than K.

In contrast, nucleus sampling only considers the smallest set of tokens that have a cumulative likelihood greater than some threshold pᵢ instead of considering the Top-K most probable tokens in vocabulary V. Therefore, each decoding step will consider the most likely Top-pᵢ tokens V^{(pi)}⊂V, automatically eliminating improbable tokens from being accidentally sampled through masking. The nucleus sampling function is shown below.

$${\sum }_{x ∈ {V}^{( {p}_{i} )}} p ( x \vert {x}_{1 : i - 1} ) \geq {p}_{i}$$

Continuing with FIG. 6, a single training query q₀ may be supplied by a user for the Monte-Carlo simulation 601 by the multi-agents, e.g., multiple LLMs. The single training query q₀ may be perturbed by at least one LLM in the query perturbator step in n different ways. Next, the original query q₀ and the perturbed queries qᵢ to qₙ may be individually inputted into a corresponding independent LLM in a plurality of multi-agents of LLMs, wherein the number of independent LLMs may be an n+1 number of LLMs. That is, there may be an n+1 number of LLMs that may act as the multi-agents. These multi-agents may then each generate a respective output do to an that corresponds to the respective queries and the LLM agent.

In a multi-agent simulation, independent agents collaborate and interact to find a solution. The independent agents may be e.g., at least one LLM such as, but not limited to, the Query Perturbator and the Output Generator(s). The independent agents maybe of the type: a generative pre-trained transformer (GPT) model. The parameters that may be applied to all the independent agents (including the Query Perturbator and the Output Generator(s)) may be, for example: temperature (T) of 1.0, frequency penalty of 0, presence penalty of 0, top P value of 0.95, maximum tokens of 800, stop value of none, and seed value of 123.

Additionally, the training instance parameters that may be applied for the encoder classifier model (dubbed HalluciBot) may be, for example: a graphic processing unit-based (GPU-based) instance in the cloud capable of performing AI computations and inferences, one graphic processing unit (GPU), an AI specialized GPU (i.e., specialized for performing AI computations and inferences), GPU memory with at least 16 gigabytes of GPU memory, virtual GPUs (vGPUs) with at least 16 vGPUs, and random access memory (RAM) with at least 64 gigabytes of RAM.

For example, in training HalluciBot, an example of 369,837 queries maybe evaluated, an example of 1,849,185 perturbations may be generated, and example of 2,219,022 outputs may be sampled. The total token usage may be, e.g., 717,530,842. Perturbation used may be e.g., 115,834,262 tokens, and the Output Generator(s) may use, e.g., 601,696,580 tokens. HalluciBot may be trained on e.g., 7,990,403 tokens and validated against e.g., 1,328,121 tokens, with an additional e.g., 1,305,302 tokens for testing that involves e.g., a Bidirectional Encoder Representations from Transformers based case (BERT-base-cased). Additionally, HalluciBot may achieve a validation accuracy of e.g., 47.6%, with a Top 3 accuracy of e.g., 73.0% when utilizing e.g., a robustly optimized Bidirectional Encoder Representations from Transformers approach (RoBERTa) large+Scenario model as shown in Table 1, which may denote a pretraining approach. Table 1 shows the challenge of approximating a random variable and the potential presence of noise in the empirical estimate, with accuracy measurements results for the Top 1, Top 2, and Top 3 predictions.

TABLE 1
HalluciBot multi-class evaluation statistics.

| | Top 1 Accuracy ↑ | | | Top 2 Accuracy ↑ | | | Top 3 Accuracy ↑ | | |
|---|---|---|---|---|---|---|---|---|---|
| Model | Train | Val | Test | Train | Val | Test | Train | Val | Test |
| BERT-base-cased | 49.6 | 32.2 | 27.7 | 69.7 | 49.2 | 40.7 | 81.4 | 62.7 | 56.4 |
| +Scenario | 54.1 | 38.7 | 31.3 | 72.2 | 54.8 | 46.1 | 82.8 | 67.6 | 59.3 |
| +Ordinal | 58.7 | 45.3 | 38.6 | 70.0 | 54.5 | 48.3 | 79.0 | 64.1 | 59.1 |
| RoBERTa-base | 47.6 | 34.1 | 26.6 | 66.2 | 50.1 | 42.6 | 77.9 | 62.7 | 57.3 |
| +Scenario | 52.2 | 41.5 | 34.4 | 69.2 | 57.0 | 48.4 | 79.8 | 68.6 | 59.5 |
| +Ordinal | 47.8 | 39.4 | 37.1 | 56.7 | 48.7 | 46.6 | 67.0 | 60.0 | 57.8 |
| RoBERTa-large | | | | | | | | | |
| +Scenario | 61.6 | 47.6 | 38.8 | 77.5 | 62.6 | 53.1 | 85.8 | 73.0 | 63.7 |
| +Ordinal | 60.8 | 48.0 | 40.7 | 73.6 | 59.0 | 52.2 | 81.9 | 67.5 | 62.3 |

Additionally, HalluciBot's binary evaluation statistics may also be measured as shown in Table 2 below. Table 2 reports the Accuracy, F1, Precision, and Recall for all data set splits. Probability threshold t may be computed along a closed interval [0, 1] in increments of e.g., 0.001 to maximize the validation F1 score for the final model. The best ablation per base model is shown underlined, while the overall best performing model is shown in bold. It may be seen from Table 2 that differentiating the scenarios in HalluciBot's prompt yields a strong e.g., +10.3% increase in validation F1 score. The calibrated, threshold-tuned RoBERTa-based HalluciBot in Table 2 may achieve a test accuracy of e.g., 69.5% with a macro F1-score of e.g., 76.0%. Additionally, HalluciBot demonstrates strong recall scores (e.g., 89.0% validation, 82.6% testing) to effectively flag risky queries that are likely to generate at least one hallucination during inference.

TABLE 2
HalluciBot Binary Evaluation Statistics.

| | Accuracy ↑ | | | F1 Score ↑ | | | Precision ↑ | | | Recall ↑ | | |
|---|---|---|---|---|---|---|---|---|---|---|---|---|
| Model | Train | Val | Test | Train | Val | Test | Train | Val | Test | Train | Val | Test |
| BERT | 80.9 | 64.4 | 66.5 | 81.3 | 68.6 | 72.3 | 86.2 | 74.8 | 74.8 | 76.9 | 63.4 | 70.0 |
| +Scenario | 85.5 | 72.3 | 67.4 | 85.5 | 76.4 | 69.8 | 92.5 | 80.2 | 77.3 | 79.5 | 73.0 | 63.7 |
| RoBERTA | 74.7 | 64.1 | 66.1 | 73.3 | 66.5 | 69.6 | 85.1 | 78.0 | 74.4 | 64.4 | 57.9 | 65.3 |
| +Scenario | 79.8 | 73.0 | 69.0 | 79.3 | 76.8 | 71.7 | 88.8 | 81.5 | 78.4 | 71.5 | 72.6 | 66.0 |
| +Consensus | 79.3 | 73.0 | 68.7 | 79.1 | 77.0 | 71.5 | 87.2 | 81.0 | 77.7 | 71.4 | 73.3 | 66.2 |
| +Calibration | 80.3 | 73.6 | 69.5 | 81.4 | 78.8 | 73.6 | 83.6 | 78.4 | 75.6 | 79.2 | 79.2 | 71.7 |
| +τ = 0.341 | 80.4 | 73.6 | 69.5 | 81.6 | 80.2 | 76.0 | 74.7 | 72.9 | 70.3 | 90.0 | 89.0 | 82.6 |
| RoBERTA- | | | | | | | | | | | | |
| large | | | | | | | | | | | | |
| +Scenario | 84.9 | 72.9 | 68.6 | 85.0 | 76.9 | 71.1 | 92.1 | 80.9 | 78.2 | 78.8 | 73.2 | 65.3 |
| +Consensus | 83.9 | 73.1 | 68.7 | 84.0 | 77.1 | 71.7 | 90.6 | 80.8 | 77.2 | 78.3 | 73.6 | 66.9 |
| +Calibration | 84.7 | 73.5 | 69.2 | 85.5 | 78.5 | 73.0 | 88.1 | 78.9 | 76.1 | 83.1 | 78.2 | 70.1 |
| +τ = 0.326 | 84.8 | 73.6 | 69.4 | 83.5 | 80.0 | 75.6 | 75.0 | 71.8 | 70.5 | 94.2 | 90.4 | 81.6 |

Furthermore, HalluciBot's training statistics for the binary and multi-class experiments may also be measured as shown in Table 3. “Size” may be the number of learnable parameters in the models. “Total FLOP” may be the total number of floating point operations conducted in the model. “Update Steps” may be the number of parameter updates the Adam optimizer may perform on the model. Each model may be trained e.g., for 5 epochs in total. Training parameters may be found in Table 3. No difference in FLOP between BERT and RoBERTa base models may be needed as RoBERTa's parameter increase may be concentrated in a larger vocabulary. The Consensus model may be fine-tuned using mixed precision (e.g. float16), resulting in half the training time. The loss may be twice as much in the Consensus models given the dual loss functions for hallucination and consensus labels.

TABLE 3
HalluciBot training statistics for our binary and multi-class experiments.

| | | | | | | | |
|---|---|---|---|---|---|---|---|
| | | GPU | | | | | |
| | | time | Total | Update | Samples/ | Steps/ | Train |
| Model | Size | (Hours) | FLOP | Steps | Second | Second | Loss |

Binary (2-class)

| | | | | | | | |
|---|---|---|---|---|---|---|---|
| BERT-base- | 108.3M | 36.3 | 3.98E+17 | 1.89E+5 | 11.6 | 1.45 | 0.542 |
| cased | | | | | | | |
| +Scenario | | 36.0 | 3.98E+17 | 1.89E+5 | 11.7 | 1.46 | 0.487 |
| RoBERTa- | 124.6M | 34.5 | 3.98E+17 | 1.89E+5 | 12.2 | 1.52 | 0.574 |
| base | | | | | | | |
| +Scenario | | 36.1 | 3.98E+17 | 1.89E+5 | 11.6 | 1.46 | 0.518 |
| +Consensus | | 16.7 | 3.98E+17 | 1.89E+5 | 25.2 | 3.15 | 1.141 |
| RoBERTa- | 355.4M | | | | | | |
| large | | | | | | | |
| +Scenario | | 120.5 | 1.41E+18 | 1.89E+5 | 3.5 | 0.44 | 0.495 |
| +Consensus | | 53.0 | 1.41E+18 | 1.89E+5 | 7.9 | 0.99 | 1.095 |

Multi-class (7-Class)

| | | | | | | | |
|---|---|---|---|---|---|---|---|
| BERT-base- | 108.3M | 35.7 | 3.98E+17 | 1.89E+5 | 11.8 | 1.47 | 1.761 |
| cased | | | | | | | |
| +Scenario | | 35.7 | 3.98E+17 | 1.89E+5 | 11.8 | 1.47 | 1.690 |
| +Ordinal | | 36.8 | 3.98E+17 | 1.89E+5 | 11.4 | 1.43 | 1.778 |
| RoBERTa- | 124.7M | | 3.98E+17 | 1.89E+5 | 12.1 | 1.51 | 1.798 |
| base | | | | | | | |
| +Scenario | | | 3.98E+17 | 1.89E+5 | 11.8 | 1.47 | 1.733 |
| +Consensus | | | 3.98E+17 | 1.89E+5 | 12.3 | 1.54 | 1.902 |
| RoBERTa- | 355.4M | | | | | | |
| large | | | | | | | |
| +Scenario | | 120.2 | 1.41E+18 | 1.89E+5 | 3.5 | 0.44 | 1.509 |
| +Consensus | | 117.3 | 1.41E+18 | 1.89E+5 | 3.6 | 0.45 | 1.622 |

The configuration of the various models and their training parameters may be found in Table 4. That is, Table 4 shows that HalluciBot may fine-tuned from both a pretrained BERT and RoBERTa models. Configurations that have been changed from defaults have been highlighted in bold. Note that for training batch size and gradient accumulation steps, RoBERTa-large's hyper-parameters may be altered to fit onto the GPU being used. All models were trained using a trainer class with the Adam optimizer. Additionally, note that the Consensus model may be tuned using float16, while all the other models may be trained in full precision (float32). To address label imbalance, a weighted class loss where each class weight may be assigned to its inverted frequency in the training set may be used as part of training HalluciBot.

TABLE 4
Model configuration and hyper-parameters
for training the HalluciBots.

| | | | |
|---|---|---|---|
| Backbone | BERT-base-cased | RoBERTa-base | RoBERTa-large |
| Transformer | 4.29.2 | 4.29.2 | 4.29.2 |
| version | | | |
| Layers | 12 | 12 | 24 |
| Attention heads | 12 | 12 | 16 |
| Hidden size | 768 | 768 | 1024 |
| Intermediate | 3072 | 3072 | 4096 |
| size | | | |
| Hidden | GeLU | GeLU | GeLU |
| activation | | | |
| Hidden dropout | 0.1 | 0.1 | 0.1 |
| prob | | | |
| Attention | 0.1 | 0.1 | 0.1 |
| dropout prob | | | |
| Position | Absolute | Absolute | Absolute |
| embedding | | | |
| Precision | Float32 | Float32 | Float32 |
| Max context | 512 | 514 | 514 |
| length | | | |
| Vocab size | 28,996 | 50,265 | 50,265 |
| Total | 108.3M | 126.7M | 355.4M |
| parameters | | | |
| Learning rate | 5e−6 | 5e−6 | 5e−6 |
| Warmups | 0 | 0 | 0 |
| Scheduler type | Linear | Linear | Linear |
| Weight decay | 0 | 0 | 0 |
| Optimizer | Adam | Adam | Adam |
| Adam β₁ | 0.9 | 0.9 | 0.9 |
| Adam β₂ | 0.999 | 0.999 | 0.999 |
| Adam ε₁ | 1e−8 | 1e−8 | 1e−8 |
| Max grad norm | 1.0 | 1.0 | 1.0 |
| Training batch | 8 | 8 | 2 |
| size | | | |
| Gradient | 1 | 1 | 4 |
| accum. steps | | | |
| Number of | 5 | 5 | 5 |
| epochs | | | |
| Tokenizer | BertTokenizer | RobertaTokenizer | RobertaTokenizer |
| Fast | True | True | True |
| Padding | Max_length | Max_length | Max_length |
| strategy | | | |
| Truncation | True | True | True |
| Dataset shuffle | 42 | 42 | 42 |
| seed | | | |

The Ordinal Layer in the models may be implemented using an example machine learning framework such as PyTorche as shown below, although another suitable machine learning framework may also be utilized. The example as shown below may accept scalar values from any model and output a multi-class probability distribution for n_classes.

```
  # Ordinal.py
  import torch
  import torch.nn as nn
  import torch.nn.functional as F
  # Base Layer For Ordinal Prediction
  class OrdinalLayer(nn.Module):
    def_{——}init_{——}(self, n_classes, func=torch.sigmoid):
      super( )._{——}init_{——}( )
      self.func = func
      self.theta = nn.Parameter(torch.linspace(−1, 1, n_classes − 1))
      self.mask = torch.tensor([1] + [0 for _ in range(n_classes − 2)])
    def forward(self, x, return_prob=False):
      # B: Batch Size
      # Input: x −> (B, *, 1)
      size = x.size( )
      x = self.threshold − x.view(−1, 1)
      x = torch.cat((
        torch.zeros(x.size(0), 1),
        self.func(x), # any cdf
        torch.ones(x.size(0), 1)
        ), dim =−1)
x = x[:, 1:] − x[:, −1]
# Directly gives log probs,
# Use NLL as they my not be softmaxed
# Return: Log Probs
# x −> (B, *, N_CLASSES)
if return_prob:
    return x.view(*size[:−1], −1)
return (x + 1e−8).log( ).view(*size[:−1], −1)
@property
def threshold(self):
    return (self.theta * self.mask + F.softplus(self.theta) * (1 − self.mask)).cumsum(−1)
# Wrapped Loss to avoid Softmax
class OrdinalLoss(nn.Module):
    def_{——}init_{——}(self, **kwargs):
      super( )._{——}init_{——}( )
      self.loss = nn.NLLLoss(**kwargs)
    def forward(self, x, y):
      # x −> Logits, size: (B, C)
      # y −> Labels, list (B) (like cross entropy)
      return self.loss(x, y)
```

As shown in FIG. 6, the Monte Carlo simulation 601 involves two types of agents: the Query Perturbator and n+1 Output Generator(s). The purpose of the multi-agent simulation may be to generate independent outputs after perturbing the query q₀ to observe the rate of hallucination. The presence of n+1 queries and agents is to ensure a balanced representation of hallucination, preventing skewed results towards either extreme. The set of outputs generated by the agents may then be evaluated against the ground truth value y to estimate the hallucination rate. Through multiple samplings across all a plurality of queries (e.g., 369,837 queries), HalluciBot may be trained to accurately identify and assess the risk of hallucination associated with a query before its generation.

The Query Perturbator as part of the Monte Carlo simulation 601 enables perturbations of the query q₀ to induce diversity to disentangle the generation process from any potential training bias. The Query Perturbator generates lexically distinct variations while retaining key semantic information. The Query Perturbator may be a generative pre-trained transformer (GPT) LLM agent that generates various n perturbations (e.g., n=5 perturbations) to the query q₀ while retaining the same semantic meaning of q₀. In effect, the generation process may be summarized as returning a set of [symbol] ={q₀, q₁, . . . , qₙ} query perturbations of size n+1. The Query Perturbator's singular purpose may be to: rewrite the query in {n} radically different ways. One prompt call may be sufficient to discourage duplicates. Temperature (T) may be set to 1.0 to prioritize creativity and lexical diversity. The perturbations inject variability into the Monte Carlo simulation 601, which may be critical for observing diverse outputs and hallucinations.

The Output Generator(s) as part of the Monte Carlo simulation 601 may generate various outputs. As an example, for a perturbed set [symbol] for a sample query q₀, the Output Generator(s) may consist of | [symbol] |=n+1 six independent generative pre-trained transformer (GPT) LLM agents to generate output answers aᵢ∈ [symbol] for each variation qᵢ∈ [symbol] . The LLM agent may receive: (1) for extractive data class type queries, a prompt with the query qᵢ alongside context cᵢ, (2) for multiple-choice data class type queries, candidate choices kᵢ∈K, and (3) for abstractive data class type queries, no additional context. Temperature (T) for all data class types may be set to 1.0 to stress test and encourage diversity.

Table 5 shows the prompt templates. For multiple-choice data class type experiments, there is no perturbation of original choices kᵢ∈K, and enumerate them in a consistent order for all perturbations qᵢ∈ [symbol] . The output generator(s) produces output answers aᵢ∈A for each perturbed query qᵢ∈ [symbol] . In an example, the number of agents may be set to n=5, yielding n+1=6 queries and outputs per example. For extractive data class type output generation, the context may be denoted as cᵢ.

TABLE 5
Prompt templates for all generative pre-trained
transformer (GPT) LLM agents.
Prompt Templates

| Agent | Prompt |
|---|---|
| Query Perturbator | Rewrite the query in {n} radically |
| | different ways. |
| | Query: {qᵢ} |
| Extractive Output Generator | Answer the user's query. |
| | Context: {ci} |
| | Query: {qᵢ} |
| | Answer: |
| Multiple-Choice Output Generator | Answer the user's query. |
| | Query: {qᵢ} |
| | A) {k₀} |
| | . . . |
| | Z) {kₘ} |
| | Answer: |
| Abstractive Output Generator | Answer the user's query. |
| | Query: {qᵢ} |
| | Short answer: |

An example prompt program function that may be used for query rewriting may have a program code as shown below.

```
  def prompt_creator(hallucibot_mode=None, hallucibot_outputs=None):
    # Naive Rewrite
    if hallucibot_mode is None:
      preamble = “You are a helpful expert query correction agent designed to
    improve user queries when needed in a manner that a novice user can easily
    understand. Your goal is to take an input user query and only rewrite it if you think
    that a novice user might find it ambiguous and fail a downstream task. If it is
    ambiguous rewrite the query while ensuring that all important information in the
    query given by the user is present in your rewrite. This means that any user who reads
    the output rewritten by you will be able to easily understand the question and answer
    it accurately and could cause hallucinations in a downstream task. Note that some
    questions might already be clearly understood by a novice user and succeed in the
    downstream task. These questions do not need to be rewritten.”
    # HalluciBot Feedback
    elif hallucibot_mode == “basic”:
      preamble = f “You are a helpful expert query correction agent designed to
    improve user queries when needed in a manner that a novice user can easily
    understand. Your goal is to take an input user query that has been evaluated using a
    group of expert critics to have a majority label of ‘{hallucibot_outputs}’ and produce
    a better rewritten version if needed.\
      A label of ‘hallucinate’ is caused by ambiguous text/information in a query
    that will cause it to be misunderstood by a novice user causing them to fail in a
    downstream task.\
      A label of ‘not hallucinate’ does not have this issue and can be easily
    understood by a novice user who will then succeed in the downstream task. If the
    label is ‘hallucinate’, your task is to rewrite the query while ensuring that all
    important information in the query given by the user is present in the your rewrite.
    This means that any user who reads the output rewritten by you will be able to easily
    understand the question and answer it accurately. If the label is ‘not hallucinate’ your
    task is to return the user input as is without any modifications.”
    # With Consensus
    elif hallucibot_mode == “rbd”:
      hb_prediction, hb_consensus_prediction = hallucibot_outputs
      if hb_consensus_prediction == “LABEL_0”:
        hb_consensus_prediction = “All of the expert critics returned the same
        evaluation.”
      elif hb_consensus_prediction == “LABEL_1”:
        hb_consensus prediction = “A minority of expert critics disagreed
        with the majority critic consensus about the phrase.”
      preamble = f “You are a helpful expert query correction agent designed to
    improve user queries when needed in a manner that a novice user can easily
    understand. Your goal is to take an input user query that has been evaluated using a
    group of six expert critics to have a majority label of ‘{hb_prediction}’ and produce a
    better rewritten version if needed. ‘{hb_consensus_prediction}’.\
      A label of ‘hallucinate’ is caused by ambiguous text/information in a query
    that will cause it to be misunderstood by a novice user causing them to fail in a
    downstream task.\
      A label of ‘not hallucinate’ does not have this issue and can be easily
    understood by a novice user who will then succeed in the downstream task. If the
    label is ‘hallucinate’, your task is to rewrite the query while ensuring that all
    important information in the query given by the user is present in the your rewrite.
    This means that any user who reads the output rewritten by you will be able to easily
    understand the question and answer it accurately. If the label is ‘not hallucinate’ your
    task is to return the user input as is without any modifications.”
    suffix = “Carefully read the entire user query and always return the output as a JSON
object with just one key labeled ‘rewritten_query’ that corresponds to the rewritten question.
DO NOT ANSWER THE GIVEN USER QUESTION AS THIS WILL AUTOMATICALLY
FAIL THE DOWNSTREAM TASK.″
    return preamble + “\n” + suffix
```

The Monte Carlo simulation 601 may provide an empirical estimate into the hallucination rate pₕ(q₀) for an original training query q₀. As described above, the hallucination may be the outcome of multiple confounding variables and thus, it may be highly unlikely that a tractable closed-form solution will be able to model hallucinations. Thus, a Monte Carlo simulation 601 may be used to derive empirical estimations of hallucination rates in LLMs, since this technique may be frequently used to map probability in the presence of random variable inference. Thus, the probability density that a query induces hallucination may be estimated via Monte Carlo simulation 601.

In general, the concept of a Monte Carlo simulation may be a technique used to approximate unknown quantities of interest when it may be difficult to derive an exact solution. Thus, Monte Carlo simulation 601 may be particularly useful when dealing with hidden latent variables that cannot be directly observed, such as the case of hallucination caused by interacting with a complex random variable (e.g., LLM). To address this challenge, Monte Carlo simulation may be used. The idea here being to conduct a multi-agent Monte Carlo simulation for each query in the training set, the multi-agent referring to the different independent LLMs. By doing so, the probability of hallucination may be estimated by observing the accuracy rate per query across lexical perturbations. The more simulations that are conducted, the more accurate the estimation becomes. For example, a series of 369,837 multi-agent Monte Carlo simulations may be performed to examine hallucination rates across perturbations for any query q₀.

Therefore, the hallucination rate pₕ(q₀) for query q₀ may be estimated given the ground truth y and set of answers aᵢ∈A. By deriving labels to estimate pₕ(q₀), HalluciBot may be trained to approximate the true risk of hallucination. That is, the probability of hallucination for a query q₀, denoted as pₕ(q₀), may be empirically estimated based on the output answer aᵢ∈ [symbol] of the Monte Carlo simulation 601 with multi-agents, i.e., multi-agent Monte Carlo simulation. Let the indicator function [symbol] be defined to measure the incorrectness of an output answer aᵢ with respect to the ground truth y for the query q₀, then the hallucination rate with pₕ(q₀) and [symbol] function is shown below.

$${p}_{h} ( {q}_{0} ) \approx \frac{1}{n + 1} \sum 𝕀 [ {a}_{i} \neq y ]$$

Undergoing this Monte Carlo simulation 601 with multi-agents, the encoder-based classifier model/encoder classifier model (for short), dubbed HalluciBot, may be trained to predict the probability for any query q, before the generation of the query, the probability that the query may yield a hallucination and to predict the expected consensus of outputs sampled. Thus, given any query q, which may also be denoted as q₀ at inference 602, may be inputted the HalluciBot to generate an estimated hallucination probability before the generation of the query, pₕ(q₀). That is, an inference 602 regarding an estimated hallucination probability before the generation of the query, pₕ(q₀), may be generated by HalluciBot for any query q.

To assess the propensity to hallucinate, the problem may be simplified by considering two response values: whether q₀ produces any hallucination or not. Thus, the binary values may be defined for the probability of any hallucination as p_{b}(q₀). Furthermore, a secondary consensus label p_{c}(q₀) may be created that may act as a proxy for the agreement of the query. The secondary consensus label maps the set of unique answers to 1 if there is any disagreement, otherwise 0 may be assigned for perfect agreement (1 denoting a unique answer). Therefore, a two (2) head output Consensus model may be trained to predict the hallucination probability p_{b}(q₀), and if the query may cause confusion or a secondary consensus p_{c}(q₀). The probability p_{b}(q₀) and the secondary consensus p_{c}(q₀) may be defined as shown below.

$${p}_{b} ( {q}_{0} ) = \{ \begin{matrix}1 & if {p}_{h} ( {q}_{0} ) > 0 \\ 0 & if {p}_{h} ( {q}_{0} ) = 0\end{matrix}$$

$${p}_{c} ( {q}_{0} ) = \{ \begin{matrix}1 & if \vert \{ {a}_{i} \vert {a}_{i} ∈ \} \vert > 1 \\ 0 & if \vert \{ {a}_{i} \vert {a}_{i} ∈ \} \vert = 1\end{matrix}$$

HalluciBot may be trained to estimate the occurrence of hallucinations with multi-class labels when queried and sampled under n+1 trials. To facilitate training, a proportion of classes may be converted into discrete classes by multiplying the original estimate pₕ(q₀) by the number of independent agents n+1. This transformed variable may be denoted as [symbol] [pₕ(q₀)], as shown below.

$$𝔼 [ {p}_{h} ( {q}_{0} ) ] = ⌊ ( n + 1 ) \cdot {p}_{h} ( {q}_{0} ) ⌋$$

That is, HalluciBot may be trained once the Monte Carlo simulation 601 is complete using a training corpus composed of e.g., 369,837 queries spanning e.g., thirteen (13) different datasets. These queries encompass extractive, multiple-choice, and abstractive dataset scenarios. Each dataset scenario, with or without additional context, may affect the hallucination rate of a generative pre-trained transformer (GPT) LLM. The estimates provided via the Monte Carlo simulation 601 may be proportional to an approximation of the hallucination rates.

In an example, using a synthetic labeled set of queries q₀ and their rate of hallucinations pₕ(q₀), an encoder classifier model based on a Bidirectional Encoder Representations from Transformers (BERT) and a robustly optimized Bidirectional Encoder Representations from Transformers (RoBERTa) to estimate the hallucination probability density from the Monte Carlo simulation 601. Two versions may be trained: a binary model to estimate the propensity that a query can result in a hallucination, and a consensus-aware model that may predict the expected agreement of outputs if sampled n+1 times. In an example, the Monte Carlo simulations 601 may constrain the number of perturbations to e.g., n=5, and when including the original query and output, the hallucination rate may be modeled for e.g., n+1=6 modes, which translates to increments of e.g., 16.6% in hallucination rates.

A query's scenario may be encoded that may be determined based on an ablation study to explore if incorporating the query's scenario mitigates hallucinations. To create the prompt, the original query q₀ may be prepend with either [EXTRACTIVE], [MULTIPLE CHOICE], or [ABSTRACTIVE], using the format «{tag}{q₀}». The additional context provides valuable signals related to the hallucination rate of the original query. The queries may be encoded as they appear in the original datasets.

The ablation study examines the impact of perturbations on the robustness of a GPT LLM in question-answering (QA) tasks by comparing two strategies: Single Query, Multiple Outputs (SINGLE) and Single Query, Multiple Perturbations, Single Output (MULTI). In the SINGLE strategy, n+1 outputs may be sampled from the original query q₀. In the MULTI strategy, n perturbations of the original query q₀ may be used, and each perturbation qᵢ may be answered once.

Table 6 below shows that while the baseline accuracy remains consistent, the lower bound accuracy may drop by e.g., 12.1 points in the MULTI setting. Additionally, the agreement metrics, as indicated by Fleiss's κ, may decrease by e.g., 12.5 points, indicating reduced consistency. In summary, (1) the SINGLE strategy results in higher agreement and lower-bound accuracy while (2) the MULTI strategy increases response diversity and hallucination rates but offers a slight improvement in upper-bound accuracy for extractive and multiple Choice scenarios. This suggests that perturbations may enhance query quality by introducing necessary diversity, despite minor variations in modal accuracy. That is, the ablation study showed that perturbations may induce output diversity and thus, a MULTI strategy should be used. As such, the Monte Carlo simulation 601 with multi-agents, i.e., multi-agent Monte Carlo simulation as described in the present application may be used with the multi-agents (e.g., the LLMs) as part of training HalluciBot.

Additionally, Table 6 also shows that introducing perturbations, rather than sampling n+1 outputs for query q₀, results in a e.g., 13-point spread between the lower and upper bound accuracy, a e.g., 12.5 point decrease in Fleiss's κ for agreement, while the modal accuracy remains largely unchanged. This suggests that perturbations inject variability into the Monte Carlo simulation 601, which remains critical for observing diverse outputs and hallucinations.

TABLE 6
Comparing Single Query Multiple Outputs (SINGLE) vs. Single Query Multiple
Perturbations Single Output (MULTI) Monte Carlo Experiments.

| | | | Accuracy | | | | Agreement | | | |
|---|---|---|---|---|---|---|---|---|---|---|
| | Scenario | | Base | Mode | Lower | Upper | μ_{D} | Hη | M₂ | K |
| | Experiment | # | ↑ | ↑ | ↑ | ↑ | ↑ | ↑ | ↑ | ↑ |
| Single | Extractive | 85,7347 | 89.8 | 90.3 | 83.6 | 94.6 | 89.8 | 91.4 | 92.0 | 90.4 |
| experiment | Multiple- | 80,813 | 74.0 | 75.8 | 58.1 | 88.0 | 73.8 | 90.3 | 83.7 | 75.5 |
| | choice | | | | | | | | | |
| | Abstractive | 200,693 | 56.2 | 56.7 | 44.2 | 67.4 | 56.1 | 93.2 | 89.8 | 80.2 |
| | Total | 367,240 | 68.0 | 68.7 | 56.4 | 78.3 | 67.9 | 94.4 | 90.2 | 81.5 |
| Multi | Extractive | 85,892 | 92.1 | 91.0 | 69.0 | 97.4 | 87.2 | 85.5 | 84.3 | 75.3 |
| experiment | Multiple- | 81,697 | 76.3 | 76.8 | 47.4 | 91.6 | 71.8 | 75.2 | 71.3 | 61.9 |
| | choice | | | | | | | | | |
| | Abstractive | 202,248 | 55.9 | 53.9 | 32.9 | 67.3 | 51.2 | 81.5 | 80.0 | 69.1 |
| | Total | 369,837 | 68.6 | 67.4 | 44.3 | 79.4 | 63.9 | 81.0 | 79.1 | 69.0 |
| Delta (Δ) | Extractive | N/A | +2.3 | +0.7 | −14.6 | +2.8 | −2.6 | −5.9 | −7.7 | −15.1 |
| | Multiple- | N/A | +2.3 | +1.0 | −10.7 | +3.6 | −2.0 | −15.1 | −12.4 | −13.6 |
| | choice | | | | | | | | | |
| | Abstractive | N/A | −0.3 | −2.8 | −11.3 | −0.1 | −4.9 | −11.7 | −9.8 | −11.1 |
| | Total | N/A | +0.6 | −1.3 | −12.1 | +1.1 | −4.0 | −13.4 | −11.1 | −12.5 |

Table 6 shows a comparison of Single Query, Multiple Outputs (SINGLE) versus Single Query Multiple Perturbation Single Output (MULTI) Monte Carlo Experiments. The reported metrics may be calculated across all examples, regardless of the original dataset split. The delta (Δ) rows display the differences between the two approaches, wherein negative values may indicate the SINGLE strategy outperforming the MULTI approach in eliciting correct answers. In summary, the SINGLE approach may demonstrate a higher agreement and tighter accuracy bounds, while the MULTI approach introduces more diverse responses and hallucinations with negligible impact on modal accuracy, allowing the simulation to generate more useful labels regarding query quality compared with a SINGLE approach.

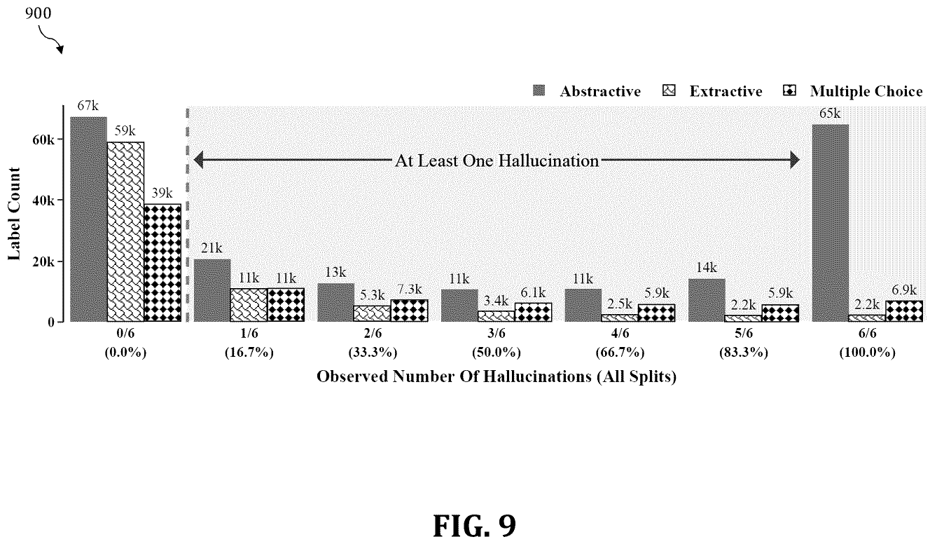

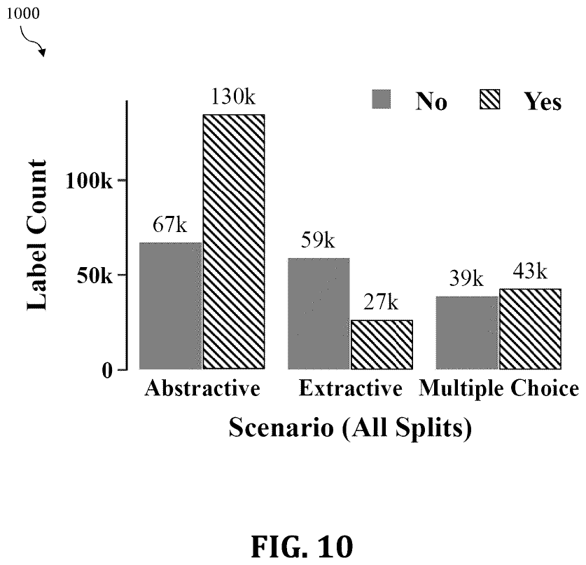

With a MULTI strategy approval, aggregated Monte Carlo results for the MULTI approach demonstrates that the relative performance of different question-answering (QA) scenarios. On average, the results as shown in Table 6 above may indicate that extractive outperforms multiple-choice, which, in turn, outperforms abstractive when subjected to perturbations. This trend suggests that the performance of the GPT LLM may be influenced by the presence of additional content. Abstractive tasks show the greatest variation in agent (e.g., GPT LLM agent) response under perturbations, highlighting the effectiveness of added context in mitigating hallucinations (see e.g., FIGS. 9 and 10).

For extractive scenario: an agent (e.g., GPT LLM) may performs well on a dataset with context. The mode accuracy (e.g., 91.0%) and agreement (e.g., 75.3%) of the agents are high. Even under radical perturbations, having unaltered context provides robustness to the agent's capacity to answer correctly. For multiple-choice scenario: access to answer choices mitigates hallucinations across perturbations. The ensemble accuracy may be slightly higher than the baseline accuracy (e.g., +0.5%), showcasing that multiple agents may slightly improve accuracy rates. For an abstractive scenario: when no additional context is provided, the GPT LLM may achieve a mode accuracy of e.g., 53.9% under perturbations. Additionally, there may be a significant dispersion of hallucination rates compared to other scenarios (see e.g., FIG. 9). Moreover, there may be a significant variation in results among different datasets, with variations in mode accuracy and baseline accuracy.

Additionally, an analysis of the Monte Carlo simulation 601 with the multi-agents (e.g., LLM agents) may include analysis of consensus, dissent, corrective, and erroneous scenarios. Consensus may arise when the original query and the majority of perturbed queries produce the correct answer. Dissent may arise when the majority of LLM agents disagree with the correct output generated for the original query. Corrective arises when the original query's generated answer may be incorrect, but the majority agrees on the correct answer. Finally, erroneous may arise when both the original query's answer and the majority of LLM agents may be incorrect. The consensus and corrective scenarios contribute to improvements in accuracy, while higher instance of dissent and erroneous cases may result in lower performance. In experiments with the Monte Carlo simulations, the LLM agents demonstrated consistent behavior in the majority of perturbations.

Various metrics may be used to assess the Monte Carlo simulations 601, wherein the metrics may also bifurcate between whether metric requires labels to compute, denoted as supervised (S) and unsupervised (U) metrics. The following notations may be used regarding these metrics:
1. q_{j,0} denotes a j-th example, original query.
2. q_{j,i} denotes a j-th example, i-th perturbation of a query.
3. [symbol] ⱼ denotes a set of query variations for q_{j,i}∀I.
4. yⱼ denotes ground truth for query q_{j,0}.
5. a_{j,i} denotes an output answer for a j-th example, i-th output.
6. [symbol] ⱼ denotes a set of output answers for q_{j,i}∀i.
7. n denotes a number of perturbations.
8. n+1 denotes a number of perturbation with q_{j,0}.
9. m denotes a number of examples.
10. kⱼ denotes a number of allowed answer states.
11. f_{j,I} denotes a frequency of a_{j,i} across all i.

Accuracy metrics, a type of supervised metric, may be computed. Accuracy may serve as a measure of correctness, comparing the generated output answer aᵢ to the ground truth y, using partial case-insensitive matching with an open-source library for fuzzy string matching. For multiple-choice queries, the choice label may also be considered. If there is no match between the output aᵢ and the ground truth y, then it may be assigned that [symbol] [aᵢ≠y]→1; otherwise, [symbol] [aᵢ=y]→0. The results may be compared to the baseline (original query q₀, output a₀), the mode (most common aᵢ), the lower bound (all correct), and the upper bound (at least one aᵢ correct).

Since an original query q_{j,0} may be in an answer set [symbol] ⱼ, the baseline accuracy against the ensemble metrics, such as lower-bound performance, upper-bound performance, and plurality-based accuracy may be juxtaposed with each other. A measure of robustness in the worst-case scenario (wherein one or more raters, e.g., LLM agent, may be incorrect) and best-case scenario (wherein one rater, e.g., LLM agent, may be correct) scenarios may be performed. Letting [symbol] be the indicator function for partial matches, then A be the baseline accuracy for n samples. In addition, let Ω be the lower bound, i.e., worst-case performance under perturbations [symbol] ⱼ, and let O be the upper-bound, i.e., best-case performance. Finally, given the set of n+1 raters, let Ŷ be the aggregate responses by the mode of answer set [symbol] ⱼ as a proxy for plurality voting, then the various following functions may define the terms A, Ω, O, and Ŷ.

$$A = \frac{1}{m} {\sum }_{j = 1}^{m} 𝕀 [ {a}_{j , 0} = {y}_{j} ]$$

$$Ω = \frac{1}{m} {\sum }_{j = 1}^{m} {min}_{i} 𝕀 [ {a}_{j , i} = {y}_{j} ] \leq A$$

$$O = \frac{1}{m} {\sum }_{j = 1}^{m} {max}_{i} 𝕀 [ {a}_{j , i} = {y}_{j} ] \geq A$$

$$\hat{Y} = \frac{1}{m} {\sum }_{j = 1}^{m} 𝕀 [ mode \{ {a}_{j , i} \vert {a}_{j , i} ∈ {𝒜}_{j} \} = {y}_{j} ]$$

Continuing with accuracy metrics, since q_{j,0} denotes the original query, the relationship between accuracy A, lower-bound performance Ω, and upper-bound performance O is as follows: Ω≤A≤O. If the raters randomly guessed, then accuracy A and mode Ŷ for kⱼ choices may be 1/kⱼ. The lower-bound Ω may approach the following limit as shown below.

$$Ω = {lim}_{{k}_{j} \to ∞} {( \frac{1}{{k}_{j}} )}^{n + 1} \approx 0$$

The upper-bound performance O would then be the probability of one success for n+1 trials. This is shown below.

$$O = 1 - {( \frac{{k}_{j} - 1}{{k}_{j}} )}^{n + 1}$$

Agreement metrics, with varying types of supervised or unsupervised metrics, may be computed. Agreement metrics may be needed because accuracy alone may be insufficient for evaluating the agreement among multiple agents (e.g., LLMs). To assess agreement, statistical measures may be computed for the Monte Carlo simulations including, but not limited to, Item Difficulty (μD), Fleiss's Generalized κ, mean normalized certainty (MNC)/Entropy (Hη), and Gibbs' M₂ Index. Further details of these statistical measures are described below. These statistical measures may help to evaluate agreement levels amongst the independent agents. For instance, high agreement on an incorrect answer may indicate a misconception, while low agreement may suggest confusion or a poorly formulated query. To address these potential limitations in the encoder classifier model dubbed HalluciBot, a dual cross-entropy loss may be introduced based on hallucination rates and consensus to improve HalluciBot's ability to distinguish good queries from bad queries.

One example of an agreement metric may be item difficulty, which may be a type of supervised metric. For each split, the average item difficulty μ_{D} may be the mean percentage of correct responses per query. It may be a measure of the collective difficulty of the queries for the raters (e.g., LLM agents). The baseline for random guessing may be the expected value of a Bernoulli distribution, [symbol] [μD]=1/k. The term μ_{D} may be defined as shown below.

$${μ}_{D} = \frac{1}{m} {\sum }_{j = 1}^{m} ( \frac{1}{n + 1} {\sum }_{i = 0}^{n} 𝕀 [ {a}_{j , i} = {y}_{j} ] )$$

A second example of an agreement metric may be mean normalized certainty (MNC), which may be a type of unsupervised metric. Entropy H may quantify the degree of uncertainty in a set of qualitative responses. It may be maximized for uniform distributions (complete uncertainty) while minimized for consistent categorizations. The rater entropy H may be normalized by the maximum entropy allowed Hₘₐₓ. The scale may be reversed such that 1 indicates certainty and 0 for uncertainty. Let f_{j,i} denote the frequency of answer candidate aᵢ for an example qⱼ, and kⱼ be the number of total allowable choices (such as unique states). Then proportion p_{j,I} and MNC H_{η} may be defined as shown below.

$${p}_{j , i} = \frac{{f}_{j , i}}{n + 1}$$

$$\begin{matrix}{H}_{η} = 1 - 𝔼 [ \frac{H}{{H}_{max}} ] \\ = 1 + \frac{1}{m} {\sum }_{j = 1}^{m} [ {\sum }_{i = 0}^{{k}_{j}} \frac{{p}_{j , i} log ( {p}_{j , i} )}{log ( {k}_{j} )} ]\end{matrix}$$

A third example of an agreement metric may be Gibbs' M₂ Index, which may be a type of unsupervised metric. This index may be a standardized metric measuring the ratio of the variance of a multinomial distribution to the variance of a binomial. Since each perturbation may be an independent trial, and the answer responses may be categorized into exactly one of kⱼ outcomes, each round of the Monte Carlo simulation may be a multinomial simulation. Therefore, let p_{j,i} be the proportion of observations for the i-th category and kⱼ be the number of allowed categories. For readability, the index may be reversed such that M₂=1 when the raters (e.g., LLM agents) are certain and 0 when uniform. Then, M₂ may be defined as shown below.

$${M}_{2} = 1 - \frac{1}{m} [ \frac{{k}_{j}}{{k}_{j} - 1} ( 1 - {\sum }_{i = 0}^{{k}_{j}} {( {p}_{j , i} )}^{2} ) ]$$

A fourth example of an agreement metric may be Fleiss's Kappa, which may be a type of unsupervised metric. Inter-rater agreement may be measured through Fleiss' Generalized κ. This metric may calculate the degree of agreement in responses over what would be expected by random chance, with 1 indicating complete agreement and 0 for none. Let f_{j,i} be the frequency of answer choice aᵢ for example qⱼ, then the expected agreement by chance P̅ₑ and observed agreement P̅₀̅ for n+1 raters may be defined as shown below.

$${\overline{P}}_{e} = {\sum }_{i = 0}^{{k}_{j}} {( \frac{1}{m ( n + 1 )} {\sum }_{j = 1}^{m} {f}_{j , i} )}^{2}$$

$${P}_{j} = \frac{1}{n ( n + 1 )} [ ( {\sum }_{i = 0}^{{k}_{j}} {( {f}_{j , i} )}^{2} ) - ( n + 1 ) ]$$

$${\overline{P}}_{o} = \frac{1}{m} {\sum }_{j = 1}^{m} {P}_{j}$$

Then κ may be the ratio of the degree of agreement achieved over the degree of agreement attainable through pure chance. Note that κ may be affected by the number of raters and categories, with fewer categories often yielding higher κ values. The term κ may be defined as shown below.

$$κ = \frac{{\overline{P}}_{o} - {\overline{P}}_{e}}{1 - {\overline{P}}_{e}}$$

A fifth example of an agreement metric may be Cronbach's Alpha (α), which may be a type of supervised metric. For measures of internal consistency, Cronbach's α may be used for dichotomous choices, in which 1 may denote correct and 0 may denote incorrect. Let m be the number of samples,

$${σ}_{y}^{2}$$

may be each sample's score variance across the n+1 raters, and

$${σ}_{x}^{2}$$

may be the variance across the total count of correct responses per rater. Then Cronbach's α may be defined as shown below.

$$α = \frac{m}{m - 1} ( 1 - \frac{{\sum }_{j = 1}^{m} {σ}_{y}^{2}}{{σ}_{x}^{2}} )$$

Additionally, metrics regarding abusive or sensitive content may also be compiled. For example, a small subset of 2,293 samples registered AttributeError (1,081) or InvalidRequestError (1,212). The former (i.e., AttributeError) may be triggered when violent or explicit content are generated, while the latter (InvalidRequestError) may be triggered through prompt filtering, such as when violent or explicit terms appear in the prompt.

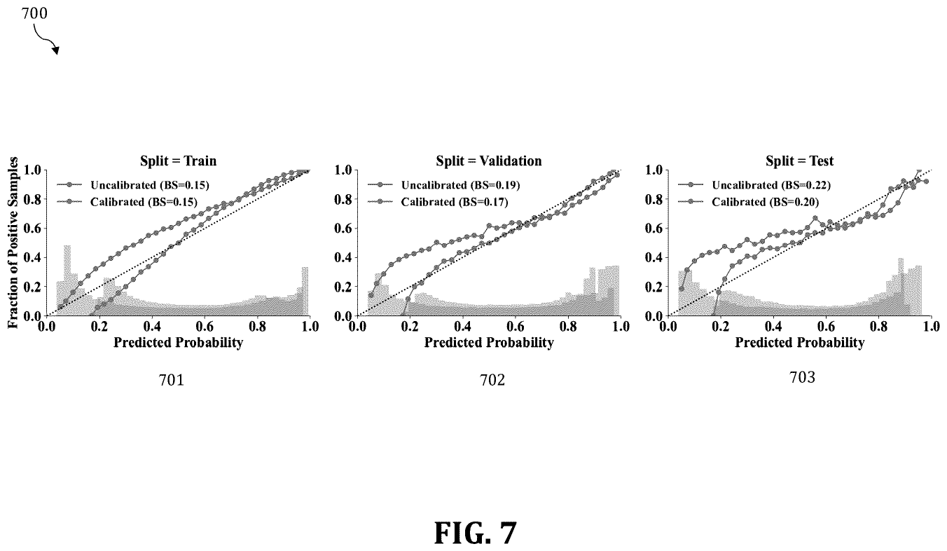

FIG. 7 illustrates example calibration graphs 700 for training an encoder classifier model in predicting hallucination of a machine learning (ML) model before a generation of a query according to an embodiment. The example calibration graphs 700 show that calibrating the models with e.g., Platt scaling may improve the discriminating power for borderline queries, where the observed number of hallucinations may be minimal (y∈{1, 2}).

The first calibration graph 701 plots fraction of positive samples versus predicted probability with an example calibrated curve (bottom curve) with Brier Scores (BS) of 0.15 and an uncalibrated curve (top curve) with BS of 0.15. The first calibration graph 701 also shows that the data split may involve training data.

Continuing with FIG. 7, the second calibration graph 702 plots fraction of positive samples versus predicted probability with an example calibrated curve (bottom curve) with BS of 0.17 and an uncalibrated curve (top curve) with BS of 0.19. The second calibration graph 702 also shows that the data split may involve validation data.

Continuing with FIG. 7, the third calibration graph 703 plots fraction of positive samples versus predicted probability with an example calibrated curve (bottom curve) with BS of 0.20 and an uncalibrated curve (top curve) with BS of 0.22. The third calibration graph 703 also shows that the data split may involve test data.

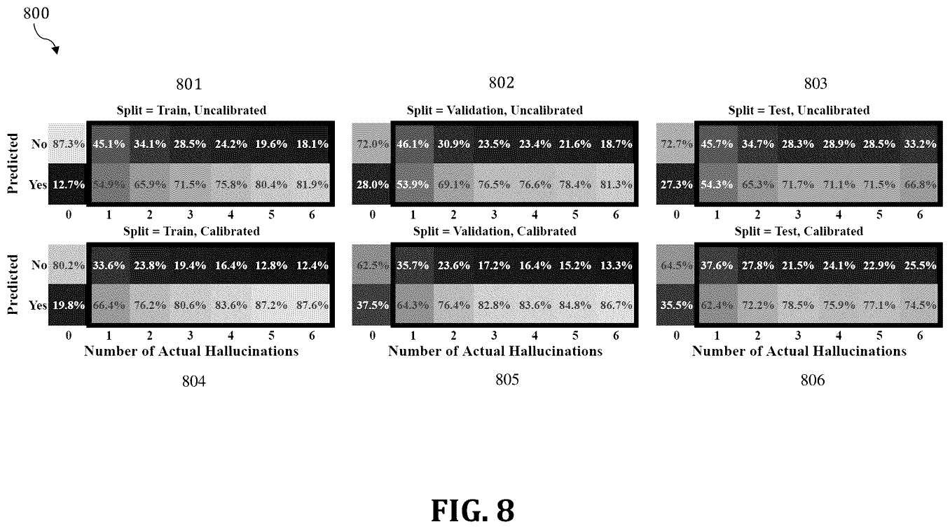

FIG. 8 illustrates example predicted hallucination matrices 800 of training an encoder classifier model in predicting hallucination of a machine learning (ML) model before a generation of a query according to an embodiment. The example predicted hallucination matrices 800 show predicted hallucination labels juxtaposed versus observed hallucination rates (i.e., number of actual hallucinations) during the Monte Carlo simulation, as shown in the calibrated matrices 804, 805, 806. The values of 1-6 with highlights may correspond to the binary label of “Yes-Hallucinatory” (y=1) during training. Notably, there may be significant confusion in queries that are borderline (denoted at the borderline of values 1, 2) rather than majority hallucinatory prone (denoted with values of 3-6). That is, queries at borderline values of 1, 2 may or may be hallucinatory (hence the significant confusion), whereas queries at values of 3-6 tend to be hallucinatory (hence the majority hallucinatory).

Continuing with FIG. 8, matrix 801 shows a data split that may include training data and uncalibrated data. The matrix 802 shows a data split that may include validation data and uncalibrated data. The matrix 803 shows a data split that may include test data and uncalibrated data. The matrix 804 shows a data split that may include training data and calibrated data. The matrix 805 shows a data split that may include validation data and calibrated data. The matrix 806 shows a data split that may include test data and calibrated data. Additionally, it is noted that these values are example values and are not intended to limit or restrict the present application to those values.

FIG. 9 illustrates an example graph 900 showing example distributions of observed number of hallucinations associated with different data scenarios of training an encoder classifier model in predicting hallucination of a machine learning (ML) model before a generation of a query according to an embodiment. The example graph 900 shows a distribution of the observed number of hallucinations per scenario for all data splits. For extractive data class types, additional context may mitigate the rate of hallucination. For multiple-choice data class type, distractors may cause confusion amongst the multi-agents (e.g., the LLMs) uniformly. However, for abstractive data class type, no additional information may cause massive disparities in correctness, with most of the simulations resulting in no hallucinations or all hallucinations. Additionally, it is noted that these values are example values and are not intended to limit or restrict the present application to those values.

The various different datasets used for training the encoder classifier model, dubbed HalluciBot, comprise of thirteen (13) datasets divided into three (3) types of datasets: extractive question-answering (QA) datasets, multiple-choice QA datasets, and abstractive QA datasets. The three types of datasets may then be split into training datasets, validation datasets, and testing datasets, wherein these data splits are maintained for each dataset across the different types of datasets to prevent information leakage to HalluciBot. In an example, there may be 302,492 training datasets, 44,491 validation datasets, and 22,854 testing datasets. Again, it is noted that these values are example values and are not intended to limit or restrict the present application to those values.

An example of the extractive QA datasets may include, but not limited to, a reading comprehension dataset with 100,000 answerable and 50,000 unanswerable questions. Answers may be derived from a context cᵢ span. For extractive QA, the queries that may be answered (e.g., 86,821) may be used. HalluciBot may be trained on for instance, 80,049 example queries. For the validation set, 5,834 items may be evaluated that may be answered. The non-answerable queries may be excluded because: (1) in a zero-shot setting, it may be difficult to determine if the model refuses to answer; (2) given that the query may be transformed into a semantically equivalent yet lexically distinct variation, it may be difficult to determine if the new query would be answerable from the context.

Regarding the multiple-choice QA dataset, one example of the multiple-choice QA dataset may include, but not limited to, a truthfulness QA dataset with a QA task that may gauge the “truthfulness” of the independent agents (e.g., the LLMs). The truthfulness QA dataset may include for example, 817 questions that may encompass for example, 38 categories intended to elicit false beliefs in domains such as “misconceptions” or “conspiracy theories”. For the multiple-choice approach, all the candidates may be provided but only one candidate would be correct. The Output Generator(s) may then perform a selection. The truthfulness QA may help measure whether the perturbed variations of the query may act as an adversarial force to elicit false beliefs.

A second example of the multiple-choice QA dataset may include, but not limited to, a “Physical Interaction: Question Answering” dataset focusing on physical commonsense through dichotomous choices. For example, the tests in this dataset may help with the ability of the LLMs to understand how to use everyday materials. The dataset may include for example, 16,113 training data samples and for example, 1,838 validation samples.

A third example of the multiple-choice QA dataset may include, but not limited to, dataset that may feature e.g., 57 subjects from science, technology, law, humanities, and social sciences in a multiple-choice format. Each query fed to the Output Generator(s) may be provided to the perturbed query and the original answer choices. Then, may be asked for the best choice. Accuracy may be measured by the best match of the label/choice in the set of responses. For example, there may be e.g., 14,042 test data samples, e.g., 1,531 validation data samples, and e.g., 285 development data samples.

A fourth example of the multiple-choice QA dataset may include, but not limited to, a dataset that tests scientific commonsense knowledge by being comprised of elementary science multiple-choice questions from a data corpus with scientific graphs and tables. The train-val-test split for the dataset may be e.g., 4,957 training data samples, e.g., 500 validation data samples, and e.g., 500 testing data samples.

A fifth example of the multiple-choice QA dataset may include, but not limited to, a dichotomous QA set of yes/no questions. For example, the context may be excluded and answers of Yes/No or True/False may be asked. There are e.g., 9,427 training data samples, e.g., 3,270 validation data samples, and e.g., 3,245 test data samples.

A fifth example of the multiple-choice QA dataset may include, but not limited to, a scientific dataset containing e.g., 13,679 science questions covering Physics, Biology, and Chemistry, broken into e.g., 11,679 training data samples, e.g., 1,000 validation data samples, and e.g., 1,000 test data samples. Each query may be paired with an answer and three distractors. The supporting evidence may be omitted and reliance may be based solely on the candidates and the Output Generator(s)'s general knowledge. Since the multiple-choice answer may generally be consistently situated in the order of the choices, the answers may be randomized once before formatting. This may be to enforce the model to rely on semantics instead of ordinal patterns.

A sixth example of the multiple-choice QA dataset may include, but not limited to, an AI reasoning challenge dataset that may consist of e.g., 7,787 questions from grade-school level science exams. The AI reasoning challenge dataset may contain e.g., 2,590 hard questions, amalgamated from data samples that were answered incorrectly by both retrieval and word co-occurrence algorithms. There are e.g., 1,119 training data samples, 299 validation data samples, and 1,172 test data samples. Most samples have e.g., 4 answer choices, with <1% having 3 or 5 choices.

A seventh example of the multiple-choice QA dataset may include, but not limited to, an AI reasoning easy dataset that may consist of e.g., 5,197 questions with a train-val-test-split of 2,251; 570; and 2,376.

An eighth example of the multiple-choice QA dataset may include a math dataset that enables an isolation of the LLMs and/or encoder classifier model on math problems. The test set does not have answers; thus, enabling a focus on the validation dataset of e.g., 4,475 data samples.

For an abstractive QA dataset, one example of the abstractive QA dataset may be, but not limited to, the reading comprehension dataset with 100,000 answerable and 50,000 unanswerable questions that was previously used for the extractive QA dataset and repurposed as the abstractive QA dataset. By omitting the context from the Output Generator(s)'s prompt, the model may be conditioned on the transformed query alone.

A second example of the abstractive QA dataset may be, but not limited to, the truthfulness QA dataset that was previously used in the first example of the multiple-choice QA dataset with a QA task that may gauge the “truthfulness” of the independent agents (e.g., the LLMs). The truthfulness QA dataset may include for example, 817 questions that may encompass for example, 38 categories intended to elicit false beliefs in domains such as “misconceptions” or “conspiracy theories”. For abstractive QA dataset, the LLM may construct any free-text answer and match the result against the candidates via cosine similarity. The best match may be either correct or a distractor.

A third example of the abstractive QA dataset may be, but not limited to, an online encyclopedia dataset that comprises of e.g., 3,047 questions and e.g., 29,258 sentence pairings. Although originally crafted for information retrieval tasks, the online encyclopedia dataset may be repurposed as an abstractive task by filtering for the e.g., 1,473 sentences that were labeled as the answer to the corresponding questions. From these QA pairings, we answers may be generated for each perturbation. Then the labeled passage and generated sentence are aligned. If a high semantic similarity (>60%) between the answer and passage exists, then the answer may be considered as correct.

A fourth example of the abstractive QA dataset may be, but not limited to, the scientific dataset containing e.g., 13,679 science questions covering Physics, Biology, and Chemistry that was previously used in the fifth example of the multiple-choice QA dataset. The scientific dataset evaluates 13,679 science exam questions without candidate choices. Correct responses may be measured by the approximate Levenshtein distance of label substrings in the generated answer.

A fifth example of the abstractive QA dataset may be, but not limited to, the over 113,000 online encyclopedia based dataset QA pairs. This dataset provides short, factual answers and may be topically diverse. An evaluation of e.g., 57,711 training data samples and 5,600 validation data samples may be performed. The test set contains no answers; therefore, meaningful metrics cannot be discerned.

A fifth example of the abstractive QA dataset may be, but not limited to, a trivia QA dataset that may diversify perturbations to general knowledge domains, leveraging e.g., 95,000 syntactically and lexically variable QA pairs authored by trivia enthusiasts. Only the training and validation dataset splits contain answers and correspondingly, an evaluation of e.g., 11,313 validation and 67,469 training samples may be evaluated.

FIG. 10 illustrates an example binary distribution of data labels 1000 associated with training an encoder classifier model in predicting hallucination of a machine learning (ML) model before a generation of a query according to an embodiment. The example binary distribution of data labels 1000 shows binary distribution of data labels for different scenarios of data splits, wherein at least one hallucination may occur during the simulation (“Yes”) and wherein a hallucination did not occur (“No”). The data labels being associated with data splits being abstractive, extractive, and multiple-choice data class types.

Table 7 below shows the training splits for HalluciBot with the binary distribution of data labels for different scenarios of data splits.

TABLE 7
Training data splits for HalluciBot.

| | Train | Validate | Test |
|---|---|---|---|
| Binary | | | |
| No (y = 0) | 139,142 | 17,153 | 9,306 |
| Yes (y = 1) | 163,350 | 27,338 | 13,548 |
| Observed rate | | | |
| 0.0% (y = 0/6) | 139,123 | 17,146 | 9,202 |
| 16.7% (y = 1/6) | 35,114 | 4,974 | 2,757 |
| 33.3% (y = 2/6) | 20,213 | 3,371 | 1,967 |
| 50.0% (y = 3/6) | 15,749 | 2,757 | 1,768 |
| 66.7% (y = 4/6) | 14,477 | 2,735 | 1,970 |
| 83.3% (y = 5/6) | 17,123 | 3,242 | 2,171 |
| 100.0% (y = 6/6) | 60,693 | 10,266 | 3,019 |
| Scenario | | | |
| Extractive | 80,049 | 5,843 | N/A |
| Multiple-Choice | 45,997 | 14,127 | 21,573 |
| Abstractive | 176,446 | 24,521 | 1,281 |
| Total | 302,492 | 44,491 | 22,854 |

Additionally, an analysis regarding well-formedness of the different data splits may also be performed. For example, a syntactically aware well-formedness scoring RoBERTa model may be trained a well-formedness query dataset to evaluate the grammatical correctness and completeness of e.g., 1,881,005 synthetically generated queries. The analysis indicates that the perturbations created by e.g., the generative pre-trained transformer (GPT) LLM(s) may consistently exhibit a high level of coherence, as indicated by their well-formedness score of e.g., 0.87. In contrast, the original queries achieve a well-formedness score of e.g., 0.77, representing an e.g., 11.5% decline. Table 8 below shows the well-formedness results. The datasets need not be split between training splits since there was no significant difference in the scores.

TABLE 8
Summary of the well-formedness results.

| | Scope | Original | Generated |
|---|---|---|---|
| Extractive | Train | 0.86 | 0.91 |
| | Validation | 0.85 | 0.91 |
| Multiple-choice | Train | 0.69 | 0.93 |
| | Validation | 0.60 | 0.86 |
| | Test | 0.65 | 0.85 |
| Abstractive | Train | 0.78 | 0.85 |
| | Validation | 0.80 | 0.86 |
| | Test | 0.76 | 0.91 |
| Totals | Train | 0.79 | 0.88 |
| | Validation | 0.75 | 0.87 |
| | Test | 0.65 | 0.85 |
| | Extractive | 0.86 | 0.91 |
| | Multiple-choice | 0.66 | 0.89 |
| | Abstractive | 0.78 | 0.85 |
| | Aggregated totals | 0.77 | 0.87 |

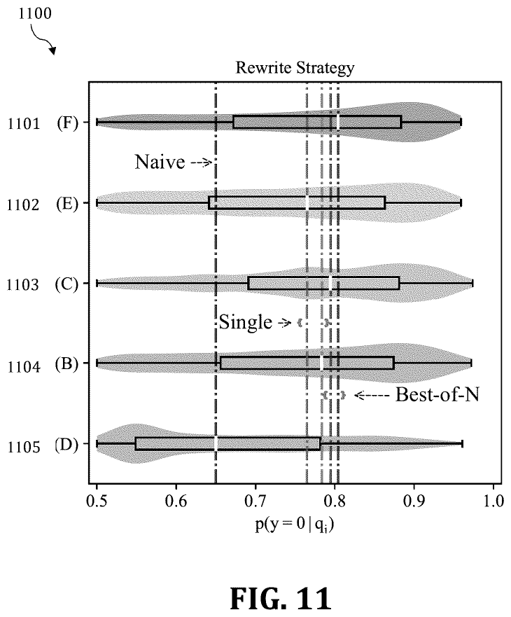

FIG. 11 illustrates an example probability graph of queries being rewritten and re-classified as non-hallucinatory 1100 as part of training an encoder classifier model in predicting hallucination of a machine learning (ML) model before a generation of a query according to an embodiment. The example probability graph 1100 shows various rewrite strategies for a query, such as, but not limited to, naïve, single, and best-of-n, as well as probability densities related to the different scenarios (F) 1101, (E) 1102, (C) 1103, (B) 1104, and (D) 1105. The different scenarios are described in Table 9 below.

Table 9 shows query generation metrics under each encoder classifier model, dubbed HalluciBot (HB), strategy for the various different scenarios. Multiple-choice queries may be evaluated on a soft accuracy criterion where the score may be +1 if any of the n generations match the ground truth. For abstractive queries, the average cosine similarity score between the ground truth and the n generation outputs may be reported. The embedding vectors for similarity computation may be obtained using a sentence transformer machine learning model.

TABLE 9
Query generation metrics under each HalluciBot (HB) strategy.

| Metrics (%) | Test | Metrics (%) | Test | Metrics (%) | Test |
|---|---|---|---|---|---|
| (A) Naïve rewrite | | (B) [HB] | | (C) [HB] | |
| | | Informed single rewrite | | Best-of-N rewrite | |
| +Class | 6.5 | +Class | 30.2 | +Class | 50.6 |
| transitions | | transitions | | transitions | |
| −Class | 3.2 | | | | |
| transitions | | | | | |
| Unneeded | 46.6 | Rewrite | | Rewrite | |
| rewrites | | accuracy | | accuracy | |
| | | Top-5 | 94.3 | Top-5 | 95.2 |
| | | Similarity | 46.9 | Similarity | 47.4 |
| | | score | | score | |
| (D) Assuming HB | | (E) [HB with | | (F) [HB with | |
| ratiocinate | | consensus] | | consensus] | |
| naïve rewrite | | Informed single rewrite | | Best-of-N rewrite | |
| (Baseline) | | | | | |
| +Class | 14.8 | +Class | 31.9 | +Class | 51.4 |
| transitions | | transitions | | transitions | |
| Rewrite | | Rewrite | | Rewrite | |
| accuracy | | accuracy | | accuracy | |
| Top-5 | 92.9 | Top-5 | 90.2 | Top-5 | 95.7 |
| Similarity | 41.7 | Similarity | 57.5 | Similarity | 55.9 |
| score | | score | | score | |

Continuing with Table 9, for the “Ratiocinate” 501 process (see for reference FIG. 5), the importance of HalluciBot as a ratiocinating process may be seen in Table 9 scenario (A) under a naïve rewriting strategy. Without HalluciBot, a naïve rewrite strategy may have the potential to convert queries originally estimated to be non-hallucinatory to hallucinatory (negative class transition), because no mechanisms exist that may differentiate queries. With HalluciBot, the test set may be restricted to just potentially hallucinatory queries (e.g., 11.2K samples), a naive rewrite (see Table 9 (D) and as shown in the example probability graph 1100 scenario (D) 1105) may only enact positive class transitions (e.g., +14.8%), converting queries originally estimated to hallucinate to be non-hallucinatory. Furthermore, HalluciBot may act as an arbitrator that may prevent computationally expensive rewrite calls for an example value of 46.6% of the test set (e.g., 10.2K samples deemed to be non-hallucinatory).

Continuing with Table 9, the “Rewrite” 502 process (see for reference FIG. 5) may act as a feedback mechanism for HalluciBot. The feedback mechanism enables the generation of an informed query (see Table 9 (B) and as shown in the example probability graph 1100 scenario (B) 1104) that results in better class transition probabilities than an uninformed rewrite strategy (see Table 9 (D) and as shown in the example probability graph 1100 scenario (D) 1105). This translates to e.g., a 14.8% positive class transition and a 1.4% increase in multiple-choice data class type accuracy as well as e.g., a 5.2% improvement in generation similarity for abstractive data class type queries. Utilizing consensus information during the query rewriting process (see Table 9 (E) and as shown in the example probability graph 1100 scenario (E) 1102) may generate a slightly larger positive class transition (e.g., 31.9% vs. 30.2%) than without (see Table 9 (B) and as shown in the example probability graph 1100 scenario (B) 1104).

Continuing with Table 9, the “Rank” 503 process (see for reference FIG. 5) may involve a best-of-n rewrite strategy (see Table 9 (C, F) and as shown in the example probability graph 1100 scenario (C) 1103 and (F) 1101), which may demonstrate, e.g., a 19.5% and a 20.4% gain in positive class transitions in both experiments over a single rewrite (see Table 9 (B, E) and as shown in the example probability graph 1100 scenario (B) 1104 and (E) 1102). Notably, the example probability graph 1100 in FIG. 11 shows that HalluciBot may be able to select better queries in the best-of-n rewrite scenario than with a single rewrite with a higher median predicted non-hallucinatory probability (e.g. 79.5% (C) 1103 vs. 78.4% (B) 1104; 80.4% (F) 1101 vs. 76.5% (E) 1102). That is, HalluciBot may evaluate the rewritten queries to be non-hallucinatory with greater probability, wherein all rewrites may be single shot without subsequent tuning or iterations. Therefore, HalluciBot's estimated probabilities may be used as a proxy reward model when ranking n sample perturbations.

That is, HalluciBot may have downstream modes, e.g., acting as a proxy reward model, wherein HalluciBot may give probabilistic feedback on the query's quality given the dual prediction heads for hallucination and consensus. HalluciBot's estimates may be used to perform a query rewriting process using an independent generative pre-trained transformer (GPT) LLM before output generation. First, with HalluciBot's inputs, the rewrite mode may perform a single-shot iterative rewrite of the query that may be classified as hallucinatory. Second, the rank mode may generate N intermediate perturbations that may be sorted using HalluciBot's class probabilities for fine-grained scoring. In an example implementation, the number of outputs may be controlled by the number of chat completion choices in an application program interface (API) call of the GPT LLM. Third, for abstractive or extractive queries classified by HalluciBot to be hallucinatory, a test may be performed as to whether switching the scenario generates more robust classifications. In essence, this test of a route mode provides the opportunity to redirect queries between Retrieval Augmented Generation (RAG) or direct inference.

Continuing with Table 9, the “Route” 504 process (see for reference FIG. 5) may involve HalluciBot routing the queries based on abstractive data class types and extractive data class types, e.g., from abstractive data class types to extractive data class types. For instance, the test set may have abstractive data class type queries (e.g., 948 abstractive data class type queries) that may have been classified as hallucinatory. Conditioned on this information, switching the scenario to extractive data class types may result in a positive class transition (e.g., +60.0% positive class transition). In contrast, a “Rewrite” 502 process (see for reference FIG. 5) without a scenario change may have a much smaller class transition (e.g., 9.7% class transition). As such, HalluciBot's ability to distinguish scenarios may help determine whether direct inference or Retrieval-Augmented Generation (RAG) may be more effective for a particular query.

Therefore, the encoder classifier model, dubbed HalluciBot, empirically estimates how the query itself may induce hallucination. HalluciBot utilizes a training corpus that consists of diverse scenarios and domains to ensure robustness. In essence, HalluciBot presents an improved technique for assessing a query's quality that absorbs the cost of iterative generations during training. HalluciBot may be implemented by for example, but not limited to, various corporations, institutions, organizations, universities, etc. for various applications, such as but not limited to, measuring user accountability and improving the robustness of an LLM's performance based on the four processes associated with HalluciBot (i.e., “Ratiocinate” 501, “Rewrite” 502, “Rank” 503, and “Route” 504). Thus, enabling a robust language generation ecosystem. Additionally, while the present description involves the use of at least one generative pre-trained transformer (GPT) LLM in training HalluciBot, it is contemplated that the framework for training HalluciBot is adaptable such that HalluciBot may be trained on any mixture of LLMs as applicable.

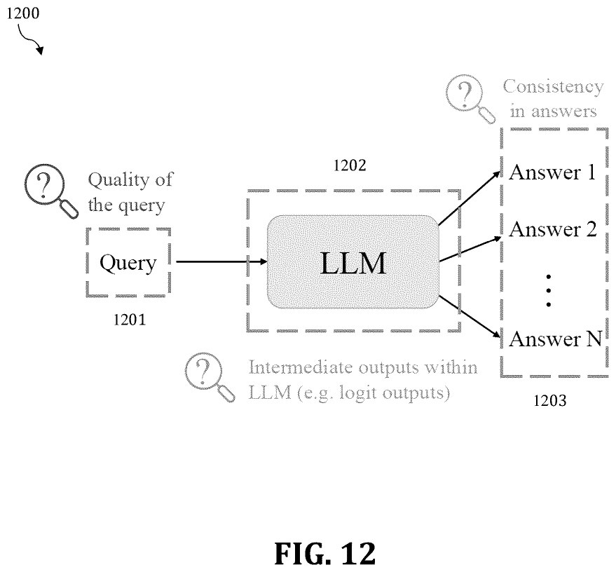

FIG. 12 illustrates an example operation of a large language model (LLM) 1200 as part of training an encoder classifier model in predicting hallucination of a machine learning (ML) model before a generation of a query according to an embodiment. In the example operation of the LLM 1200, to assess the possibility of hallucination, the status quo focuses on either the answers 1203 or the intermediate outputs within the model 1202. In contrast to the status quo, the present application instead focuses directly on assessing the quality of a query 1201, which may be quantified as to how likely such a query may lead to a hallucination.

Although the invention has been described with reference to several embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting embodiment, the computer-readable medium may include a solid-state memory such as a memory card or other package that houses one or more non-volatile read-only memories. Further, the computer-readable medium may be a random-access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure may be considered to include any computer-readable medium or other equivalents and successor media, in which data or instructions may be stored.

Although the present application describes specific embodiments which may be implemented as computer programs or code segments in computer-readable media, it may be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

Although the present specification describes various numeric values, it is noted that these values are example values and are not intended to limit or restrict the present application to those values. Accordingly, replacement values having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method of training an encoder classifier model in predicting hallucination of a machine learning (ML) model before a generation of a query, the method being implemented by at least one processor, the method comprising:
implementing a plurality of independent large language models (LLMs) that each perturb a plurality of training queries for a predetermined number (n) of times, wherein the plurality of LLMs comprises n+1;
utilizing the plurality of LLMs in performing functions comprising:
generating a perturbed output for each of the plurality of training queries by perturbing the plurality of training queries;
sampling an initial training query and each of the perturbed outputs; and
deriving empirical probability estimations of hallucinations via a computational statistical simulation on the sampled outputs; and
training the encoder classifier model based on the derived empirical probability estimations that predicts the hallucination in the ML model associated with the query before the generation of the query.

2. The method of claim 1, wherein the each of the perturbed outputs comprises a semantically equivalent and lexically distinct variation corresponding to each of the plurality of training queries.

3. The method of claim 1, wherein the training the encoder classifier model comprises at least one from among:
training the encoder classifier model in generating a binary classification that predicts whether the query results in the hallucination in the ML model; and
training the encoder classifier model with a non-reinforcement learning technique resulting in a consensus-aware proxy reward model with a feedback mechanism.

4. The method of claim 3, wherein the consensus-aware proxy reward model generates:
a probabilistic feedback regarding the quality of the query; and
a single-shot iterative automated rewrite of the query based on the probabilistic feedback.

5. The method of claim 1, wherein the query, the plurality of training queries, and the initial training query belong to an initial data class type comprising at least one from among:
extractive data class type, multiple-choice data class type, and abstractive class type.

6. The method of claim 5, further comprising:
performing a ranking of the perturbed plurality of training queries based on a best-of-n strategies for utilization by the LLMs in the sampling; and
routing the query across different modes of the trained encoder classifier model that correlate to a second data class type that differs from the initial data class type.

7. The method of claim 1, wherein the computational statistical simulation comprises a multi-agent Monte Carlo simulation; and
wherein each of the independent LLMs comprises a generative pre-trained transformer (GPT) LLM.

8. A computing apparatus for training an encoder classifier model in predicting hallucination of a machine learning (ML) model before a query generation, comprising:
a processor;
a memory;
a display; and
a communication interface coupled to each of the processor, the memory, and the display, wherein the processor is configured to:
implement a plurality of independent large language models (LLMs) that each perturb a plurality of training queries for a predetermined number (n) of times, wherein the plurality of LLMs comprises n+1;
utilize the plurality of LLMs in performing functions comprising:
generate a perturbed output for each of the plurality of training queries by perturbing the plurality of training queries;
sample an initial training query and each of the perturbed outputs; and
derive empirical probability estimations of hallucinations via a computational statistical simulation on the sampled outputs; and
train the encoder classifier model based on the derived empirical probability estimations that predicts the hallucination in the ML model associated with the query before the generation of the query.

9. The computing apparatus of claim 8, wherein the each of the perturbed outputs comprises a semantically equivalent and lexically distinct variation corresponding to each of the plurality of training queries.

10. The computing apparatus of claim 8, wherein the processor is further configured to train the encoder classifier model by at least one from among:
training the encoder classifier model in generating a binary classification that predicts whether the query results in the hallucination in the ML model; and
training the encoder classifier model with a non-reinforcement learning technique resulting in a consensus-aware proxy reward model with a feedback mechanism.

11. The computing apparatus of claim 10, wherein the processor is further configured to implement the consensus-aware proxy reward model to generate:
a probabilistic feedback regarding the quality of the query; and
a single-shot iterative automated rewrite of the query based on the probabilistic feedback.

12. The computing apparatus of claim 8, wherein the query, the plurality of training queries, and the initial training query belong to an initial data class type comprising at least one from among: extractive data class type, multiple-choice data class type, and abstractive class type.

13. The computing apparatus of claim 12, wherein the processor is further configured to:
perform a ranking of the perturbed plurality of training queries based on a best-of-n strategies for utilization by the LLMs in the sampling; and
route the query across different modes of the trained encoder classifier model that correlate to a second data class type that differs from the initial data class type.

14. The computing apparatus of claim 8, wherein the computational statistical simulation comprises a multi-agent Monte Carlo simulation; and
wherein each of the independent LLMs comprises a generative pre-trained transformer (GPT) LLM.

15. A non-transitory computer readable storage medium storing instructions for training an encoder classifier model in predicting hallucination of a machine learning (ML) model before a query generation, the non-transitory computer readable storage medium comprising executable code which, when executed by a processor, causes the processor to:
implement a plurality of independent large language models (LLMs) that each perturb a plurality of training queries for a predetermined number (n) of times, wherein the plurality of LLMs comprises n+1;
utilize the plurality of LLMs in performing functions comprising:
generate a perturbed output for each of the plurality of training queries by perturbing the plurality of training queries;
sample an initial training query and each of the perturbed outputs; and
derive empirical probability estimations of hallucinations via a computational statistical simulation on the sampled outputs; and
train the encoder classifier model based on the derived empirical probability estimations that predicts the hallucination in the ML model associated with the query before the generation of the query.

16. The non-transitory computer readable storage medium of claim 15, wherein the each of the perturbed outputs comprises a semantically equivalent and lexically distinct variation corresponding to each of the plurality of training queries;
wherein the computational statistical simulation comprises a multi-agent Monte Carlo simulation; and
wherein each of the independent LLMs comprises a generative pre-trained transformer (GPT) LLM.

17. The non-transitory computer readable storage medium of claim 15, wherein the executable code further causes the processor to train the encoder classifier model by at least one from among:
training the encoder classifier model in generating a binary classification that predicts whether the query results in the hallucination in the ML model; and
training the encoder classifier model with a non-reinforcement learning technique resulting in a consensus-aware proxy reward model with a feedback mechanism.

18. The non-transitory computer readable storage medium of claim 17, wherein the executable code further causes the processor to implement the consensus-aware proxy reward model to generate:
a probabilistic feedback regarding the quality of the query; and
a single-shot iterative automated rewrite of the query based on the probabilistic feedback.

19. The non-transitory computer readable storage medium of claim 15, wherein the query, the plurality of training queries, and the initial training query belong to an initial data class type comprising at least one from among: extractive data class type, multiple-choice data class type, and abstractive class type.

20. The non-transitory computer readable storage medium of claim 19, wherein the executable code further causes the processor to:
perform a ranking of the perturbed plurality of training queries based on a best-of-n strategies for utilization by the LLMs in the sampling; and
route the query across different modes of the trained encoder classifier model that correlate to a second data class type that differs from the initial data class type.
